(19) United States
(12) Patent Application Publication
(10) Pub. No.: US 2021/0001538 A1
(43) Pub. Date: Jan. 7, 2021

(54) MOLD-RELEASE METHOD FOR MOLDED ARTICLE, AND MOLD-RELEASE DEVICE

(71) Applicant: DAICEL CORPORATION, Osaka-shi, Osaka (JP)

(72) Inventors: Takeshi FUJIKAWA, Tokyo (JP); Sadayuki FUKUI, Tokyo (JP)

(73) Assignee: DAICEL CORPORATION, Osaka-shi, Osaka (JP)

(21) Appl. No.: 16/978,334

(22) PCT Filed: Mar. 7, 2019
(86) PCT No.: PCT/JP2019/009153

§ 371 Date: Sep. 4, 2020

(30) Foreign Application Priority Data
Mar. 8, 2018 (JP) 2018-041942
Mar. 8, 2018 (JP) 2018-041943

(51) Int. Cl. B29C 59/00; B29C 59/02; B29C 33/44; G02B 3/00

(52) U.S. Cl. CPC B29C 59/002; B29C 59/02; B29L 2011/0016; G02B 3/0031; B29C 33/44

(57) ABSTRACT

An object of the present invention is to provide a mold-release method and a mold-release device that enable removal of a high-precision molded article from a mold. The present invention provides a mold-release method for a molded article (2) from a mold (1) and a mold-release device for carrying out the mold-release method, the molded article (2) being formed by curing a curable material supplied to a molding surface (1A) of the mold (1), and having a first surface (2A) onto which a patterned shape of the molding surface (1A) is transferred and a second surface (2B) on a back side opposite to the first surface, the method including: 1: attaching a base material (3) onto the entire second surface (2B) of the molded article (2); and
2: relatively moving the base material (3) and the mold (1) in a direction in which the base material (3) and the mold (1) are separated from each other, and thereby releasing the molded article (2) from the mold (1).

### TECHNICAL FIELD

The present invention relates to a mold-release method for a molded article from a mold and a mold-release device therefor. The molded article is preferably an imprint molded article. The present application claims priority to JP 2018-041942 and JP 2018-041943 filed in Japan on Mar. 8, 2018, the contents of which are incorporated herein.

### BACKGROUND ART

In recent years, there has been a demand for mobile electronic devices, such as mobile phones and smartphones, to improve product value by mounting an optical component, such as a sensor or a camera. In addition, such products have been reduced in size and thickness year by year, and smaller and thinner components are required to be used therefor. To address such a demand, injection molding has been utilized to produce components so far, but the injection molding method has reached its limit in terms of reducing size and thickness. Thus, an imprint molding method has attracted attention as a new molding method that replaces the injection molding method. However, in the imprint molding method, problems with releasability of the molded article from the mold tend to arise, and molding precision may be impaired.

As mold-release methods for a molded article from a mold in imprint molding, there have been reported: a method of releasing a molded article from a mold including inserting a pin between the mold and the molded article (for example, Patent Document 1); a method of releasing a molded article from a mold in a vertical direction while holding a peripheral part of the molded article (for example, Patent Document 2); a method of releasing a molded article from a mold in an oblique direction while holding a part of the molded article (for example, Patent Documents 3 and 4); a method of applying vibration or ultrasonic vibration to a mold to assist mold release (for example, Patent Document 5); a method of tilting a mold to release it from a molded article (for example, Patent Document 6), and the like.

### CITATION LIST

### Patent Document

Patent Document 1: JP 2007-118552 A

Patent Document 2: JP 2003-181855 A

Patent Document 3: JP 2008-284822 A

Patent Document 4: WO 2010/142958

Patent Document 5: JP 2012-254559 A

Patent Document 6: JP 2012-253303 A

### SUMMARY OF INVENTION

### Technical Problem

In the imprint molding method, a fine shape pattern is generally formed in a mold, and high molding precision is required. In particular, in a case where an assembly of a plurality of products is molded through single molding, as in the case of a wafer-level lens array, it is necessary to make the assembly into individual products by dicing. Therefore, the molded article is required to have small overall warpage, and further to have excellent positional precision among the individual products. However, in the methods of Patent Documents 1 to 4, excessive force is applied to a part of the molded article, particularly, at the start of mold release, and thus problems arise such as warping in the molded article and deterioration in positional precision. Furthermore, when a resin or glass is used in a mold, the strength of the mold itself is low, and it is thus difficult to employ a method that includes applying a force from outside as in Patent Documents 5 and 6.

Therefore, an object of the present invention is to provide a mold-release method that enables removal of a high-precision molded article from a mold.

Another object of the present invention is to provide a mold-release device that enables removal of a high-precision molded article from a mold.

### Solution to Problem

As a result of earnest research to solve the problems described above, the present inventors have found that, when a molded article attached to a molding surface of a mold is released from the mold, a base material or an adhesive sheet having a specific adhesive force is attached onto an entire surface of the molded article, where the surface is not adhered to the mold, such that the force is uniformly distributed throughout the molded article during the mold release, with the result that a high-precision molded article with small overall warpage and high positional precision of the molding pattern can be stably removed from the mold. The present invention was completed based on these findings.

That is, a first aspect of the present invention provides a mold-release method for a molded article from a mold,

the molded article being formed by curing a curable material supplied to a molding surface of the mold, and having a first surface onto which a patterned shape of the molding surface is transferred and a second surface on a back side opposite to the first surface,

the method including:

(1a) attaching a base material onto the entire second surface of the molded article; and

(2a): relatively moving the base material and the mold in a direction in which the base material and the mold are separated from each other, and thereby releasing the molded article from the mold.

In the mold-release method for a molded article of the first aspect, the molded article may be an array in which two or more optical elements are arranged two-dimensionally on the first surface and the array has a substrate part that joins the optical elements together.

In the mold-release method for a molded article of the first aspect, it is preferable that at least a planar part onto which the base material is attachable should be present on the second surface.

In the mold-release method for a molded article of the first aspect, the base material may be a resin sheet.

The resin sheet may have an adhesive layer on one surface thereof.

The mold-release method for a molded article of the first aspect may further include:

(3a) peeling the base material from the second surface of the molded article obtained in (2a).

The mold-release method for a molded article of the first aspect may further include:

(3a′) dicing the molded article obtained in (2a), the molded article having a plurality of optical elements arranged two-dimensionally on the first surface and the second surface fixed by the base material, thereby making the optical elements into individual optical members.

In the mold-release method for a molded article of the first aspect, the optical elements may be wafer-level lenses.

A second aspect of the present invention provides a mold-release method for a molded article from a mold,

the molded article being formed by curing a curable material supplied to a molding surface of the mold, and having a first surface onto which a patterned shape of the molding surface is transferred and a second surface on a back side opposite to the first surface,

the method including:

(1b) attaching an adhesive sheet having an adhesive force of 3 N/20 mm or more onto the entire second surface of the molded article; and

(2b) relatively moving the adhesive sheet and the mold in a direction in which the adhesive sheet and the mold are separated from each other, and thereby releasing the molded article from the mold.

In the mold-release method for a molded article of the second aspect, the molded article may be an array in which two or more optical elements are arranged two-dimensionally on the first surface and the array has a substrate part that joins the optical elements together.

In the mold-release method for a molded article of the second aspect, it is preferable that at least a planar part onto which the adhesive sheet is attachable should be present on the second surface.

In the mold-release method for a molded article of the second aspect, the adhesive sheet may be a laminate including a base material and an adhesive layer laminated on one surface of the base material, and the base material may be a resin.

The mold-release method for a molded article of the second aspect may further include:

(3b) peeling the adhesive sheet from the second surface of the molded article formed in (2b).

The mold-release method for a molded article of the second aspect may further include:

(3b′) dicing the molded article obtained in (2b), the molded article having a plurality of optical elements arranged two-dimensionally on the first surface and the second surface fixed by the adhesive sheet, thereby making the optical elements into individual optical members.

In the mold-release method for a molded article of the second aspect, the optical elements may be wafer-level lenses.

In the mold-release methods for a molded article of the first and second aspects, the curable material may be a curable epoxy resin composition.

In the mold-release methods for a molded article of the first and second aspects, the material constituting the mold may be at least one selected from the group consisting of resins, metals, or glass.

In the mold-release methods for a molded article of the first and second aspects, at least a part of a patterned region of the molding surface of the mold may be treated with a mold-release agent.

Also, a third aspect of the present invention provides a mold-release device for a molded article from a mold,

the molded article being formed by curing a curable material supplied to a molding surface of the mold, and having a first surface onto which a pattern of a molding surface is transferred and a second surface on a back side opposite to the first surface,

the device including:

an attaching unit configured to attach a base material onto the second surface;

a moving unit configured to move the base material and the mold relatively;

an attaching control unit configured to control the attaching unit to attach the base material onto the entire second surface of the molded article; and

a movement control unit configured to control the moving unit to relatively move the base material and the mold in a direction in which the base material and the mold are separated from each other.

A fourth aspect of the present invention provides a mold-release device for a molded article from a mold,

the molded article being formed by curing a curable material supplied to a molding surface of a mold, and having a first surface onto which a patterned shape of a molding surface is transferred and a second surface on a back side opposite to the first surface,

the device including:

an attaching unit configured to attach an adhesive sheet onto the second surface;

a moving unit configured to move the adhesive sheet and the mold relatively;

an attaching control unit configured to control the attaching unit to attach the adhesive sheet onto the entire second surface of the molded article; and

a movement control unit configured to control the moving unit to relatively move the adhesive sheet and the mold in a direction in which the adhesive sheet and the mold are separated from each other.

### Advantageous Effects of Invention

Since the mold-release method and mold-release device of the present invention have the configurations described above, when the molded article is released from the mold, the force is uniformly distributed throughout the molded article. This results in a high-precision molded article with small overall warpage and high positional precision of the molding pattern can be stably removed from the mold.

The mold-release method or mold-release device of the present invention is used for a molded article of an assembly of a plurality of products through single molding (preferably, imprint molding), thereby making it possible to stably produce a high-precision molded article with small overall warpage and small deviation in positional relationship among the individual products, and thus can be suitably applied, for example, to production of a wafer-level lens array for effectively producing a sensor lens or camera lens for mobile electronic devices including mobile phones or smartphones.

### BRIEF DESCRIPTION OF DRAWINGS

FIG. 1 is a schematic diagram illustrating an example of a mold in a first or second aspect of the present invention, in which (a) is a perspective view, (b) is a top view, and (c) is a side view.

FIG. 2 is a schematic diagram illustrating an example of a molded article in the first or second aspect of the present invention, in which (a) is a perspective view, (b) is a top view, and (c) is a side view.

FIG. 3 is a schematic diagram illustrating an example of a state in which a first surface of the molded article in the first or second aspect of the present invention is adhered to a molding surface of the mold, in which (a) is a perspective view, (b) is a top view, and (c) is a side view.

FIG. 4 is an explanatory view illustrating an example of (1a) of a mold-release method of the first aspect of the present invention, in which (a) is a perspective view, (b) is a top view, and (c) is a side view.

FIG. 5 is an explanatory view illustrating an example of (2a) of the mold-release method of the first aspect of the present invention, in which (a) is a perspective view and (b) a side view.

FIG. 6 is an explanatory view illustrating another example of (2a) of the mold-release method of the first aspect of the present invention, in which (a) is a perspective view and (b) a side view.

FIG. 7 is a schematic diagram illustrating an example of a molded article formed by the mold-release method of the first aspect of the present invention in which a base material is attached onto a second surface, in which (a) is a perspective view, (b) is a top view, and (c) is a cross-sectional view in X-X′.

FIG. 8 is a schematic diagram illustrating an example of an adhesive sheet in the second aspect of the present invention, in which (a) is a perspective view, (b) is a top view, (c) is a side view, and (d) is an enlarged view of the side view.

FIG. 9 is an explanatory view illustrating an example of (1b) of a mold-release method of the second aspect of the present invention, in which (a) is a perspective view, (b) is a top view, and (c) is a side view.

FIG. 10 is an explanatory view illustrating an example of (2b) of the mold-release method of the second aspect of the present invention, in which (a) is a perspective view and (b) a side view.

FIG. 11 is an explanatory view illustrating another example of (2b) of the mold-release method of the second aspect of the present invention, in which (a) is a perspective view and (b) a side view.

FIG. 12 is a schematic diagram illustrating an example of a molded article formed by the mold-release method of the second aspect of the present invention in which an adhesive sheet is attached onto a second surface, in which (a) is a perspective view, (b) is a top view, and (c) is a cross-sectional view in X-X′.

FIG. 13 is a block diagram illustrating an example of a mold-release device according to a third or fourth aspect of the present invention.

FIG. 14 is a flowchart illustrating a flow of an example of the mold-release method according to the third or fourth aspect of the present invention.

FIG. 15 is a schematic diagram of a bottom mold used in examples and comparative examples, in which (a) is a top view and (b) is a cross-sectional view in A-A′.

FIG. 16 is an explanatory view (cross-sectional view) illustrating a process of Production Example 1.

FIG. 17 is an explanatory view illustrating a mold-release method of Comparative Example 1, in which (a) is a top view and (b) is a cross-sectional view in Y-Y′.

FIG. 18 is an explanatory view illustrating a mold-release method of Comparative Example 2, in which (a) is a top view and (b) is a cross-sectional view in I-I′, or

### DESCRIPTION OF EMBODIMENTS

Typical embodiments of the present invention will be described with reference to the drawings, but the present invention is not limited thereto. The embodiments are merely illustrative.

### [Mold-Release Method for Molded Article]

The mold-release method for a molded article according to a first aspect of the present invention (hereinafter sometimes referred to as “mold-release method of the first aspect of the present invention”) is a mold-release method for a molded article (hereinafter, sometimes referred to as “molded article of the first aspect of the present invention”) from a mold (hereinafter, sometimes referred to as “mold of the first aspect of the present invention”), the molded article being formed by curing a curable material supplied to a molding surface of the mold, and having a first surface onto which a patterned shape of the molding surface is transferred and a second surface on a back side opposite to the first surface,

the method including:

(1a) attaching a base material onto the entire second surface of the molded article; and

(2a) relatively moving the base material and the mold in a direction in which the base material and the mold are separated from each other, and thereby releasing the molded article from the mold.

The mold-release method for a molded article according to a second aspect of the present invention (hereinafter sometimes referred to as “mold-release method of the second aspect of the present invention”) is a mold-release method for a molded article (hereinafter, sometimes referred to as “molded article of the second aspect of the present invention”) from a mold (hereinafter, sometimes referred to as “mold of the second aspect of the present invention”), the molded article being formed by curing a curable material supplied to a molding surface of the mold, and having a first surface onto which a patterned shape of the molding surface is transferred and a second surface on a back side opposite to the first surface,

the method including:

(1b) attaching an adhesive sheet having an adhesive force of 3 N/20 mm or more (hereinafter sometimes referred to as “adhesive sheet of the present invention”) onto the entire second surface of the molded article; and

(2b) relatively moving the adhesive sheet and the mold in a direction in which the adhesive sheet and the mold are separated from each other, and thereby releasing the molded article from the mold.

Hereinafter, the mold-release method of the first aspect of the present invention and the mold-release method of the second aspect of the present invention may collectively be referred to simply as “mold-release method of the present invention”.

Hereinafter, the mold of the first aspect of the present invention and the mold of the second aspect of the present invention may collectively be referred to simply as “mold of the present invention”.

Hereinafter, the molded article of the first aspect of the present invention and the molded article of the second aspect of the present invention may collectively be referred to simply as “molded article of the present invention”.

### Mold

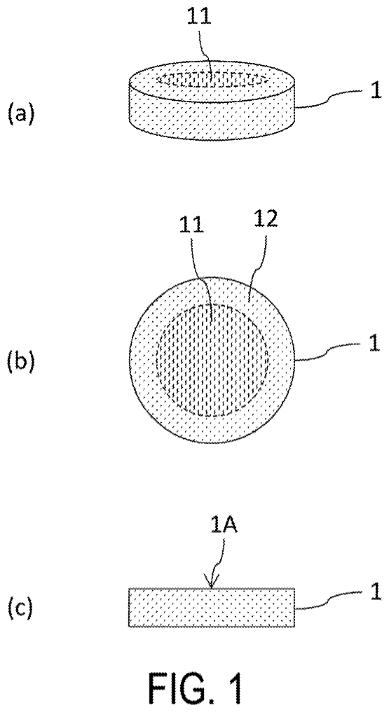

FIG. 1 illustrates a schematic diagram of an example of the mold of the first and second aspects of the present invention (mold of the present invention), in which (a) is a perspective view, (b) is a top view, and (c) is a side view.

The mold 1 of the present invention has at least a molding surface 1A having a patterned region 11 (the illustration of its patterned shape is omitted). The molding surface 1A of the mold 1 of the present invention may have a non-patterned region 12 around the patterned region 11, in addition to the patterned region 11.

In the mold of the present invention, the patterned region is imparted with an inverted concavo-convex patterned shape corresponding to the desired shape of the molded article (inverted shape of the desired molded article) in order to impart the desired shape to the molded article. The shape of a planar surface of the patterned shape part of the mold is not particularly limited, but the aspect ratio is preferably from 0.1 to 1, more preferably from 0.5 to 1. An aspect ratio which is closer to 1 is more preferred. The aspect ratio is a proportion of a length in the longitudinal direction relative to a length in the lateral direction when the direction of the longest length of the shape of the planar surface is defined as the lateral direction. When the aspect ratio falls within the above-described range, the degree of curing of the entire molded article of the present invention tends to be uniform, so that positional deviation is unlikely to occur before and after curing. As illustrated in FIG. 1(a), the shape of the planar surface is a shape of the patterned shape part as viewed from the top surface (corresponding to FIG. 1(b)) when the mold is placed in a horizontal position such that the patterned region 11 is located in the top surface.

The material constituting the mold of the present invention is not particularly limited, and examples thereof include resins, metals, glass, and combinations of these materials.

The resin constituting the mold of the present invention is not particularly limited, and is selected with consideration of the compatibility with the curable material (wettability), the shape precision and peelability (releasability) of the molded article after curing, and the like, and examples of the resin include silicone resins (dimethylpolysiloxane and the like), fluororesins, polyolefin resins (polyethylene, polypropylene, polycyclic olefin, and the like), polyethersulfone resins, polycarbonate resins, polyester resins (polyarylate, polyethylene terephthalate, polyethylene naphthalate, and the like), polyamide resins, and polymethyl methacrylates.

The metal constituting the mold of the present invention is not particularly limited, and examples thereof include metal materials such as iron, iron alloys (stainless steel, permalloy, etc.), nickel, brass, silicon wafers, copper, copper alloys, gold, silver, cobalt, aluminum, zinc, tin, tin alloys, titanium, and chromium. When the mold of the present invention is formed from a metal, the molding surface may be provided with electroless plating with a metal material such as nickel, plating treatment such as electrocasting, photolithographic shape machining, or the like.

The material constituting the mold of the present invention is preferably a resin, especially preferably a silicone resin. When a silicone resin is used, compatibility with the curable material containing an epoxy compound and shape precision are excellent. Additionally, releasability of the molded article and flexibility of the mold are excellent and thus the molded article can be more easily removed.

The mold of the present invention may be a commercially available product or may be produced. When the mold of the present invention is to be produced, the mold can be produced, for example, by molding (preferably, imprint molding) a resin composition that forms the mold, and then heat-curing.

A mold having a desired concavo-convex shape can be used for molding the resin composition, and can be produced, for example, by the following method (1) or (2):

(1) a method in which a mold is pressed against a coating film of a resin composition coated onto a substrate, the coating film of the resin composition is cured, and then the mold is released;

(2) a method in which a resin composition is coated directly to a mold, a substrate is closely adhered on the coated resin composition, a coating film of the curable composition is cured, and then the mold is released.

At least a part of the patterned region in the molding surface of the mold of the present invention may be treated with a mold-release agent. Examples of the method for treating with the mold-release agent include a method of forming a mold-release film by coating a mold-release agent such as a fluorine mold-release agent, a silicone mold-release agent, a wax mold-release agent, or the like, and a method of forming a vapor-deposited mold-release film by vacuum deposition of a fluororesin or the like. Examples of the method for coating the mold-release agent include spray coating, dip coating, spin coating, and screen printing.

The mold-release film may be composed of a single layer or a plurality of layers. Additionally, when the mold-release film includes a plurality of layers, each of the layers may be formed of the same component, or may be formed of a different component. In the present invention, especially, a mold having, on the molding surface, a mold-release film coated with a fluorine mold-release agent is preferred from the viewpoint of providing excellent releasability.

### [Molded Article]

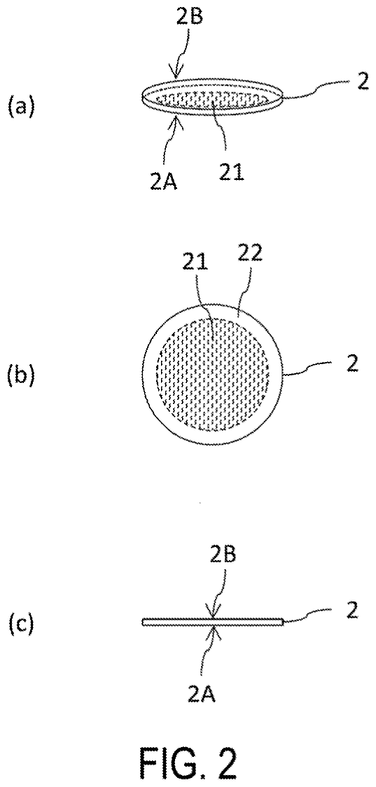

FIG. 2 illustrates a schematic diagram of an example of the molded article of the first and second aspects of the present invention (molded article of the present invention), in which (a) is a perspective view, (b) is a top view, and (c) is a side view.

A molded article 2 of the present invention has a first surface 2A onto which the patterned shape 11 of the molding surface 1A of the mold 1 of the present invention is transferred, and a second surface 2B on a back side opposite to the first surface. The shape of the molded article 2 of the present invention is not particularly limited as long as it has the first surface 2A and the second surface 2B. However, a substrate having the first surface 2A and the second surface 2B is preferred, as illustrated in FIG. 2.

The first surface 2A of the molded article of the present invention has a transfer region 21 having a shape which is transferred and inverted from the patterned shape of the patterned region 11 of the molding surface 1A of the mold of the present invention (the illustration of its patterned shape is omitted). The first surface 2A may have a non-transfer regions 22 around the transfer region 21, in addition to the transfer region 21.

The patterned shape formed in the transfer region 21 on the first surface 2A is not particularly limited, but is preferably adapted to high-quality optical members, and examples of such optical members include lenses, prisms, LEDs, organic EL elements, semiconductor lasers, transistors, solar cells, CCD image sensors, optical waveguides, optical fibers, alternative glasses (e.g., a display substrate, a hard disk substrate, and a polarization film), and optical diffraction elements. Especially, a lens of which high precision is required is preferred.

The type and shape of the lens are not particularly limited, and examples thereof include eyeglass lenses, lenses for optical equipment, lenses for optoelectronic devices, lenses for lasers, pick up lenses, lenses for on-board cameras, lenses for mobile cameras, lenses for smartphones, lenses for digital cameras, lenses for OHPs, Fresnel lenses, microlenses, and wafer-level lenses. In particular, the patterned shape can be preferably applied to a wafer-level lens that is required to be compact, thin, and highly precise.

The molded article of the present invention is not particularly limited, but can be suitably applied to an array (array of optical elements) in which two or more of elements of the optical member as described above (optical elements) are arranged two-dimensionally on the first surface, and the array has a substrate part that joins these optical elements together. The molded article of the present invention has small overall warpage and high positional precision of the molding pattern. Therefore, when the array of optical elements is made into individual optical elements, a plurality of optical elements with uniform shape precision can be obtained. In a case where the array of optical elements is a wafer-level lens array, a diameter of the lens is, for example, from 1 to 5 mm. In addition, a width of the substrate part is, for example, 1 mm or less, preferably from 0.05 to 1 mm, particularly preferably from 0.05 to 0.5 mm.

The second surface of the molded article of the present invention is not particularly limited, but may have a patterned shape, or may have a planar shape without a patterned shape. In step (1a) of the mold-release method of the first aspect of the present invention or step (1b) of the mold-release method of the second aspect of the present invention, respectively, the second surface preferably has at least a planar part onto which the base material or the adhesive sheet of the present invention is attached to be stably fixed to the second surface. A proportion of an area of the planar part relative to a total area of the second surface (100%) is not particularly limited, but is preferably 15% or more, more preferably 25% or greater, even more preferably 35% or greater. When the proportion of the area of the planar part is 15% or more, the second surface can be stably fixed to the base material or the adhesive sheet of the present invention, and the molded article can be reliably released from the mold. The upper limit of the proportion of the area of the planar part is not particularly limited, and may be 100%, i.e., the entire second surface may constitute the planar part. As illustrated in FIG. 2(a), the area of the planar part and the total area of the second surface are areas of the entire projections of the planar part and the second surface as viewed from the top surface (FIG. 2(b)) when the molded article is placed in a horizontal position such that the second surface is located in the top surface. Hereinafter, the term “area”, when used in the present specification, is defined in the same manner.

In a case where the second surface of the molded article of the present invention has a patterned shape, the second surface is not particularly limited, but preferably does not have a convex part with respect to the planar part onto which the base material or the adhesive sheet of the present invention is attached. When the second surface has a convex part with respect to the planar part, the base material or the adhesive sheet of the present invention fails to attach onto the planar part of the second surface sufficiently, and thus the molded article may not be successfully released from the mold.

In a case where the second surface of the molded article of the present invention has a patterned shape, the second surface is not particularly limited, but may have a concave part with respect to the planar part onto which the base material or the adhesive sheet of the present invention can be attached. At that time, when the molded article of the present invention is an array of optical elements, two or more concave parts present in the second surface are preferably arranged at positions corresponding to the two or more optical elements present on the first surface.

In a case where the second surface of the molded article of the present invention has a concave part with respect to the planar part onto which the base material or the adhesive sheet of the present invention is attached, a proportion of an area of the concave part to a total area of the second surface 2B (100%) is not particularly limited, but is preferably 85% or less, more preferably 75% or less, even more preferably 65% or less. When the proportion of the area of the concave part is 85% or less, the second surface can be stably fixed to the base material of the present invention or the adhesive sheet of the present invention, and the molded article can be reliably released from the mold. The lower limit of the proportion of the area of the concave part with respect to the total area of the second surface is not particularly limited, and the present invention also encompasses 0%, i.e., the case where no concave part is present in the second surface.

The molded article of the present invention can be formed by supplying the curable material to the molding surface of the mold of the present invention and curing the curable material.

The curable material is not particularly limited, but is preferably a resin that cures in a short time and has excellent heat resistance from the viewpoint of mass productivity and moldability of the molded article, and examples thereof include epoxy-based cationic curable resin compositions, acrylic radical curable resin compositions, and curable silicone resin compositions. Of these, an epoxy-based cationic curable resin composition (curable epoxy resin composition) that cures in a short time, has a short casting time to the mold, a small curing shrinkage rate and excellent dimensional stability, and does not undergo oxygen inhibition during curing is preferred.

As the epoxy resin, a well-known or commonly used compound having one or more epoxy groups (oxirane ring) in a molecule can be used, and examples thereof include alicyclic epoxy compounds, aromatic epoxy compounds, and aliphatic epoxy compounds. In an embodiment of the present invention, among them, in terms of being able to form a cured product with excellent heat resistance and transparency, a polyfunctional alicyclic epoxy compound having an alicyclic structure and two or more epoxy groups as functional groups in one molecule is preferred.

Examples of the polyfunctional alicyclic epoxy compounds specifically include:
(i) a compound having an epoxy group constituted of two adjacent carbon atoms and an oxygen atom that constitute an alicyclic ring (i.e., an alicyclic epoxy group);
(ii) a compound having an epoxy group directly bonded to an alicyclic ring with a single bond; and
(iii) a compound having an alicyclic ring and a glycidyl group.

An example of the above compound (i) having an alicyclic epoxy group includes a compound represented by Formula (i) below.

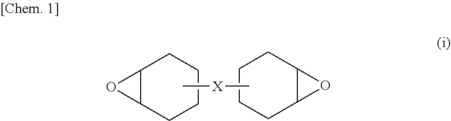

In Formula (i) above, X represents a single bond or a linking group (a divalent group having one or more atoms). Examples of the linking group include a divalent hydrocarbon group, an epoxidized alkenylene group in which carbon-carbon double bonds are partially or entirely epoxidized, a carbonyl group, an ether bond, an ester bond, a carbonate group, an amide group, and a linked group in which a plurality of the above is linked. Note that a substituent (for example, such as an alkyl group) may be bonded to a cyclohexene oxide group in Formula (i).

Examples of the divalent hydrocarbon group include a linear or branched alkylene group having from 1 to 18 carbon atoms and a divalent alicyclic hydrocarbon group. Examples of the linear or branched alkylene group having from 1 to 18 carbon atoms include a methylene group, a methylmethylene group, a dimethylmethylene group, an ethylene group, a propylene group, and a trimethylene group. Examples of the divalent alicyclic hydrocarbon group include a cycloalkylene group (including a cycloalkylidene group), such as a 1,2-cyclopentylene group, a 1,3-cyclopentylene group, a cyclopentylidene group, a 1,2-cyclohexylene group, a 1,3-cyclohexylene group, a 1,4-cyclohexylene group, and a cyclohexylidene group.

Examples of the alkenylene group in the epoxidized alkenylene group in which one, some, or all carbon-carbon double bond(s) is (are) epoxidized (which may be referred to as the “epoxidized alkenylene group”) include a linear or branched alkenylene group having from 2 to 8 carbon atoms, such as a vinylene group, a propenylene group, a 1-butenylene group, a 2-butenylene group, a butadienylene group, a pentenylene group, a hexenylene group, a heptenylene group, and an octenylene group. In particular, the epoxidized alkenylene group is preferably an epoxidized alkenylene group in which all of the carbon-carbon double bond(s) is/are epoxidized and more preferably an epoxidized alkenylene group having from 2 to 4 carbon atoms in which all of the carbon-carbon double bond(s) is/are epoxidized.

The linking group in the above X is, in particular, preferably a linking group containing an oxygen atom, and specifically, examples thereof include —CO—, —O—CO—O—, —COO—, —O—, —CONH—, and an epoxidized alkenylene group; a group in which a plurality of these groups are linked; and a group in which one or two or more of these groups and one or more of the divalent hydrocarbon groups are linked.

Representative examples of the compound represented by Formula (i) above include (3,4,3′,4′-diepoxy)bicyclohexyl, bis(3,4-epoxycyclohexylmethyl)ether, 1,2-epoxy-1,2-bis(3,4-epoxycyclohexane-1-yl)ethane, 2,2-bis(3,4-epoxycyclohexane-1-yl)propane, 1,2-bis(3,4-epoxycyclohexane-1-yl)ethane, and compounds represented by Formulas (i-1) to (i-10) below. L in Formula (i-5) below is an alkylene group having from 1 to 8 carbons, and, among them, preferably a linear or branched alkylene group having from 1 to 3 carbons, such as a methylene group, an ethylene group, a propylene group, or an isopropylene group. In Formulas (i-5), (i-7), (i-9), and (i-10) below, n1 to n⁸ each represent an integer from 1 to 30.

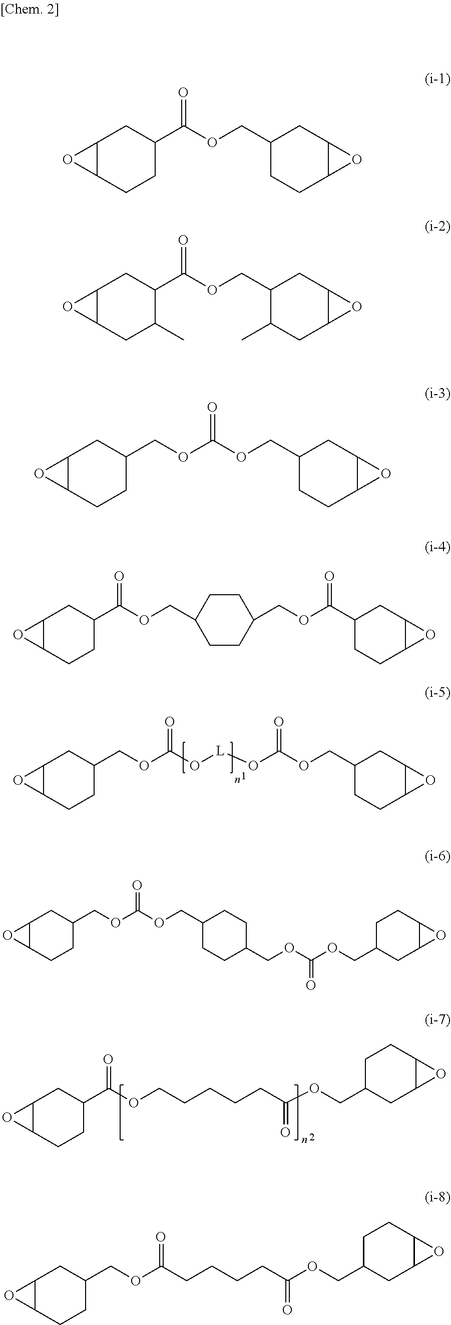

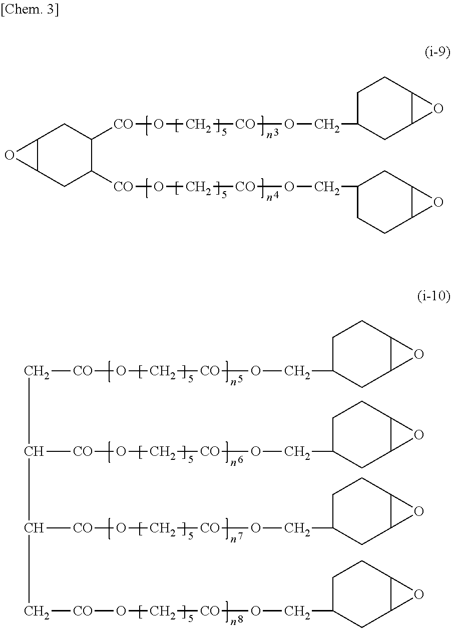

The above compound (i) having an alicyclic epoxy group also includes an epoxy-modified siloxane.

Examples of the epoxy-modified siloxane include a chain or cyclic polyorganosiloxane having a constituent unit represented by Formula (i′) below.

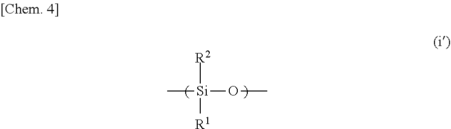

In Formula (i′) above, R1 represents a substituent containing an epoxy group represented by Formula (1a) or (1b) below, and R² represents an alkyl group or an alkoxy group.

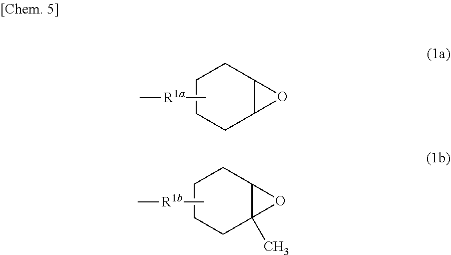

In the formulas, R^{1a} and R^{1b} are the same or different and represent a linear or branched alkylene group, and examples thereof include a linear or branched alkylene group having from 1 to 10 carbons, such as a methylene group, a methyl methylene group, a dimethyl methylene group, an ethylene group, a propylene group, a trimethylene group, a tetramethylene group, a pentamethylene group, a hexamethylene group, and a decamethylene group.

The epoxy equivalent (in accordance with JIS K7236) of the epoxy-modified siloxane is, for example, from 100 to 400 and preferably from 150 to 300.

As the epoxy-modified siloxane, for example, commercially available products can be used, for example, such as an epoxy-modified cyclic polyorganosiloxane represented by Formula (i′-1) below (trade name “X-40-2670”, available from Shin-Etsu Chemical Co., Ltd.).

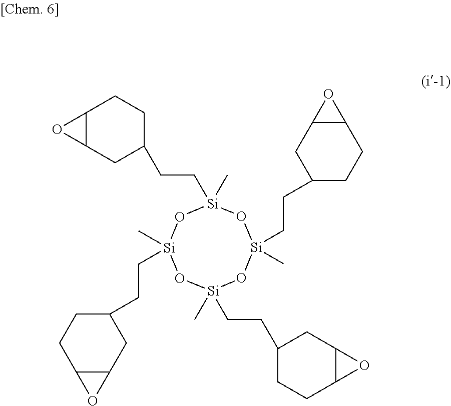 [SMILES: C[Si]1(CCC2CCC3OC3C2)O[Si](C)(CCC2CCC3OC3C2)O[Si](C)(CCC2CCC3OC3C2)O[Si](C)(CCC2CCC3OC3C2)O1]

Examples of the above compound (ii) having an epoxy group directly bonded to an alicyclic ring with a single bond include a compound represented by Formula (ii) below.

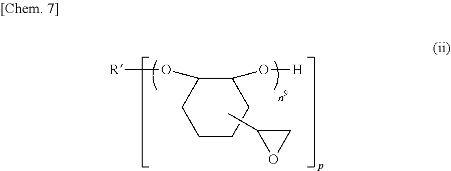

In Formula (ii), R′ is a group resulting from elimination of p hydroxyl groups (—OH) from a structural formula of a p-hydric alcohol (p-valent organic group), wherein p and n9 each represent a natural number. Examples of the p-hydric alcohol [R′—(OH)p] include polyhydric alcohols (alcohols having from 1 to 15 carbons), such as 2,2-bis(hydroxymethyl)-1-butanol. Here, p is preferably from 1 to 6, and n9 is preferably from 1 to 30. When p is 2 or greater, n9 in each group in square brackets (the outer brackets) may be the same or different. Examples of the compound represented by Formula (ii) above specifically include 1,2-epoxy-4-(2-oxiranyl)cyclohexane adduct of 2,2-bis(hydroxymethyl)-1-butanol [for example, such as the trade name “EHPE3150” (available from Daicel Corporation)].

Examples of the above compound (iii) having an alicyclic ring and a glycidyl group include hydrogenated aromatic glycidyl ether-based epoxy compounds, such as a hydrogenated bisphenol A epoxy compound, a hydrogenated bisphenol F epoxy compound, a hydrogenated bisphenol epoxy compound, a hydrogenated phenol novolac epoxy compound, a hydrogenated cresol novolac epoxy compound, a hydrogenated cresol novolac epoxy compound of bisphenol A, a hydrogenated naphthalene epoxy compound, and a hydrogenated product of a trisphenol methane epoxy compound.

The polyfunctional alicyclic epoxy compound is preferably the compound (i) having an alicyclic epoxy group and particularly preferably a compound represented by Formula (i) above (in particular, (3,4,3′,4′-diepoxy)bicyclohexyl), in terms of providing a cured product having high surface hardness and excellent transparency.

The curable resin composition in an embodiment of the present invention may contain an additional curable compound in addition to the epoxy resin as the curable compound and can contain, for example, one type, or two or more types of cationic curable compounds, such as an oxetane compound and a vinyl ether compound.

A proportion of the epoxy resin in a total amount (100 wt. %) of the curable compound contained in the curable resin composition is, for example, 50 wt. % or greater, preferably 60 wt. % or greater, particularly preferably 70 wt. % or greater, most preferably 80 wt. % or greater, and the upper limit is, for example, 100 wt. % and preferably 90 wt. %.

In addition, a proportion of the compound (i) having an alicyclic epoxy group in the total amount (100 wt. %) of the curable compound contained in the curable resin composition is, for example, 20 wt. % or greater, preferably 30 wt. % or greater, particularly preferably 40 wt. % or greater, and the upper limit is, for example, 70 wt. % and preferably 60 wt. %.

A proportion of the compound represented by Formula (i) in the total amount (100 wt. %) of the curable compound contained in the curable resin composition is, for example, 10 wt. % or greater, preferably 15 wt. % or greater, particularly preferably 20 wt. % or greater, and the upper limit is, for example, 50 wt. % and preferably 40 wt. %.

The curable resin composition preferably contains a polymerization initiator along with the curable compound, and particularly preferably contains one or more photopolymerization or thermal polymerization initiators (photocationic or thermal cationic polymerization initiators).

The photocationic polymerization initiator is a compound that initiates curing reaction of the curable compound (in particular, the cationic curable compound) contained in the curable resin composition by generating an acid with light irradiation and is formed of a cationic moiety that absorbs light and an anionic moiety that serves as a source for generating the acid.

Examples of the photocationic polymerization initiator include diazonium salt-based compounds, iodonium salt-based compounds, sulfonium salt-based compounds, phosphonium salt-based compounds, selenium salt-based compounds, oxonium salt-based compounds, ammonium salt-based compounds, and bromine salt-based compounds.

In the present invention, among these, use of a sulfonium salt-based compound is preferred because a cured product having excellent curability can be formed. Examples of the cationic moiety of the sulfonium salt-based compound include arylsulfonium ions (in particular, triarylsulfonium ions), such as a (4-hydroxyphenyl)methylbenzylsulfonium ion, a triphenyl sulfonium ion, a diphenyl[4-(phenylthio)phenyl]sulfonium ion, a 4-(4-biphenylthio)phenyl-4-biphenylylphenylsulfonium ion, and a tri-p-tolylsulfonium ion.

Examples of the anionic moiety of the photocationic polymerization initiator include [(Y)ₛB(Phf)₄₋ₛ]⁻ (where Y represents a phenyl group or a biphenylyl group, Phf represents a substituted phenyl group in which at least one of hydrogen atoms is replaced with at least one selected from a perfluoroalkyl group, a perfluoroalkoxy group, and a halogen atom, and s is an integer of 0 to 3.), BF₄⁻, [(Rf)ₜPF₆₋ₜ]⁻ (where Rf represents a substituted alkyl group in which 80% or more of hydrogen atoms are replaced with fluorine atoms, and t represents an integer of 0 to 5; AsF₆⁻; SbF₆⁻; and SbF₅OH⁻.

Examples of the photocationic polymerization initiator that can be used include (4-hydroxyphenyl)methylbenzylsulfonium tetrakis(pentafluorophenyl)borate; 4-(4-biphenylylthio)phenyl-4-biphenylylphenylsulfonium tetrakis(pentafluorophenyl)borate; 4-(phenylthio)phenyldiphenylsulfonium phenyltris(pentafluorophenyl)borate; [4-(4-biphenylylthio)phenyl]-4-biphenylylphenylsulfonium phenyltris(pentafluorophenyl)borate; diphenyl[4-(phenylthio)phenyl]sulfonium tris(pentafluoroethyl)trifluorophosphate; diphenyl[4-(phenylthio)phenyl]sulfonium tetrakis(pentafluorophenyl)borate; diphenyl[4-(phenylthio)phenyl]sulfonium hexafluorophosphate; 4-(4-biphenylylthio)phenyl-4-biphenylylphenylsulfonium tris(pentafluoroethyl)trifluorophosphate; bis[4-(diphenylsulfonio)phenyl]sulfide phenyltris(pentafluorophenyl)borate; [4-(2-thioxanthonylthio)phenyl]phenyl-2-thioxanthonylsulfonium phenyltris(pentafluorophenyl)borate; 4-(phenylthio)phenyldiphenylsulfonium hexafluoroantimonate; and commercially available products under trade names, such as “Cyracure UVI-6970”, “Cyracure UVI-6974”, “Cyracure UVI-6990”, and “Cyracure UVI-950” (these are available from Union Carbide Corporation, USA), “Irgacure 250”, “Irgacure 261”, “Irgacure 264”, and “CG-24-61” (these are available from BASF), “Optomer SP-150”, “Optomer SP-151”, “Optomer SP-170”, and “Optomer SP-171” (these are available from Adeka Corporation), “DAICAT II” (available from Daicel Corporation), “UVAC 1590” and “UVAC 1591” (these are available from Daicel-Cytec Co., Ltd.), “CI-2064”, “CI-2639”, “CI-2624”, “CI-2481”, “CI-2734”, “CI-2855”, “CI-2823”, “CI-2758”, and “CIT-1682” (these are available from Nippon Soda Co., Ltd.), “PI-2074” (tetrakis(pentafluorophenyl)borate tricumyliodonium salt, available from Rhodia), “FFC 509” (available from 3M), “BBI-102”, “BBI-101”, “BBI-103”, “MPI-103”, “TPS-103”, “MDS-103”, “DTS-103”, “NAT-103”, and “NDS-103” (these are available from Midori Kagaku Co., Ltd.), “CD-1010”, “CD-1011”, and “CD-1012” (these are available from Sartomer, USA), and “CPI-100P” and “CPI-101A” (these are available from San-Apro Ltd.).

The thermal cationic polymerization initiator is a compound that initiates a curing reaction of the cationic curable compound contained in the curable resin composition by generating an acid with heating treatment and is formed of a cationic moiety that absorbs heat and an anionic moiety that serves as a source for generating the acid. A single thermal cationic polymerization initiator can be used alone, or two or more thermal cationic polymerization initiators can be used in combination.

Examples of the thermal cationic polymerization initiator include iodonium salt compounds, and sulfonium salt compounds.

Examples of the cationic moiety of the thermal cationic polymerization initiator include 4-hydroxyphenyl-methyl-benzylsulfonium ions, 4-hydroxyphenyl-methyl-(2-methylbenzyl)sulfonium ions, 4-hydroxyphenyl-methyl-1-naphthylmethylsulfonium ions, and p-methoxycarbonyloxyphenyl-benzyl-methylsulfonium ions.

Examples of the anionic moiety of the thermal cationic polymerization initiator include the same examples as those of the anionic moiety of the photocationic polymerization initiator indicated above.

Examples of the thermal cationic polymerization initiator include 4-hydroxyphenyl-methyl-benzylsulfonium phenyl tris(pentafluorophenyl) borate, 4-hydroxyphenyl-methyl-(2-methylbenzyl) sulfonium phenyl tris(pentafluorophenyl) borate, 4-hydroxyphenyl-methyl-1-naphthylmethylsulfonium phenyl tris(pentafluorophenyl) borate, and p-methoxycarbonyloxyphenyl-benzyl-methylsulfonium phenyl tris(pentafluorophenyl) borate.

The content of the polymerization initiator is, for example, in a range from 0.1 to 5.0 parts by weight relative to 100 parts by weight of the curable compound (in particular, the cationic curable compound) contained in the curable resin composition. When the content of the photopolymerization initiator is less than the above range, curing failures may occur. On the other hand, when the content of the photopolymerization initiator exceeds the above range, coloration of the cured product tends to occur.

The curable resin composition in the present invention can be produced by mixing the curable compound, the polymerization initiator, and, as necessary, an additional component (for example, such as a solvent, an antioxidant, a surface conditioner, a photosensitizer, an anti-foaming agent, a leveling agent, a joining agent, a surfactant, a flame retardant, an ultraviolet absorber, and a colorant). The additional component is blended in an amount of, for example, 20 wt. % or less, preferably 10 wt. % or less, particularly preferably 5 wt. % or less of the total amount of the curable resin composition.

The viscosity of the curable resin composition of the present invention at 25° C. is not particularly limited, but is preferably 5000 mPa·s or less, more preferably 2500 mPa·s or less. Adjusting the viscosity of the curable resin composition of the present invention to the above-described range may improve fluidity, and suppress air bubble residues. And thus, it is possible to fill the curable resin composition into the mold while suppressing the increase in injection pressure. That is, coatability and fillability can be improved, and workability can be improved throughout the molding operation of the curable resin composition of the present invention. The viscosity in the present specification is a value measured using a rheometer (“PHYSICA UDS200” available from Paar Physica) under the conditions of a temperature of 25° C. and a rotational speed of 20/sec.

Commercially available products such as the trade names “CELVENUS OUH106” and “CELVENUS OTM107” (there are available from Daicel Corporation) can also be used as the curable resin composition in the present invention.

For example, when a photocurable resin composition is used as the curable resin composition, the curable material can be cured by ultraviolet irradiation. Examples of the light source used during the ultraviolet light irradiation include a high-pressure mercury-vapor lamp, an ultrahigh-pressure mercury-vapor lamp, a carbon-arc lamp, a xenon lamp, and a metal halide lamp. The irradiation time is dependent of the type of the light source, the distance between the light source and the coated surface, and other conditions, but is several tens of seconds at the longest. The illuminance is approximately from 5 to 200 mW. After the ultraviolet light irradiation, the curable composition may be heated (post-curing) as necessary to facilitate curing.

For example, when a thermosetting resin composition is used as the curable resin composition, the curable resin composition can be cured by heating treatment. The heating temperature is, for example, approximately from 60 to 150° C. The heating time is, for example, approximately from 0.5 to 20 hours.

The method of supplying the above-described curable material to the molding surface of the mold of the present invention and curing can preferably be performed by an imprint molding method, and examples thereof include the following methods (1) to (3):

(1) a method in which a curable material is coated to the molding surface of the mold of the present invention, a substrate is closely adhered on the curable material, the coating film of the curable material is cured, and then the substrate is peeled off;

(2) a method in which the molding surface of the mold of the present invention is pressed against a coating film of a curable material coated onto a substrate, the coating film of the curable material is cured, and then the substrate is peeled off;

(3) a method in which a curable material is coated to the molding surface of the mold of the present invention, a substrate coated with the curable material is closely adhered on the curable material, the coating film of the combined curable materials is cured, and then the substrate is peeled.

For example, when a photocurable resin composition is used as the curable material, a substrate having a light transmittance of 90% or more at a wavelength of 400 nm is preferably used as the substrate described above, and a substrate made of quartz, glass or a resin can be suitably used. Further, the light transmittance at the wavelength can be determined using a substrate (thickness: 1 mm) as a test piece and using a spectrophotometer to measure the light transmittance at the wavelength irradiated to the test piece.

For example, when a thermosetting resin composition is used as the curable material, the curable resin composition can be cured by heating treatment. The heating temperature is, for example, approximately from 60 to 150° C. The heating time is, for example, approximately from 0.5 to 20 hours.

In the methods (1) to (3), the surface of the molded article on which the substrate is peeled off and exposed is the second surface, and the surface which is retained on the molding surface of the mold of the present invention and in which the patterned shape is inverse-transferred is the first surface.

The substrate may be a mold having a patterned shape part, or may be a planar substrate. For example, when the second surface of the molded article of the present invention does not have a concavo-convex shape, a planar substrate can be used. On the other hand, when the second surface has a concavo-convex shape, a mold having the corresponding concavo-convex shape can be used as the substrate, but the substrate preferably has at least a planar part. Because the substrate has a planar part, the planar part is transferred to the second surface, and the base material or the adhesive sheet of the present invention is adhered thereto to be easily fixed stably.

The substrate may be formed from a material different from that of the mold of the present invention or may be formed from the same material. The substrate and the molding surface of the mold of the present invention may have the same or corresponding patterned shape or may have different patterned shapes.

Although a curable material is coated to at least one of the substrate and the molding surface of the mold of the present invention before overlaying, but it is preferable to use the mold of the present invention in which the curable material is coated to the molding surface, in order to prevent the generation of voids (air bubbles) in the molded article. The substrate may be coated or may not be coated with the curable material.

The curable material can be coated to the molding surface of the mold of the present invention and/or the substrate by a known or common coating method. Examples of the coating methods include spin coating, roll coating, spray coating (spraying), dispense coating, dip coating, inkjet coating, airbrush coating (airbrush spraying), and ultrasonic coating (ultrasonic spraying).

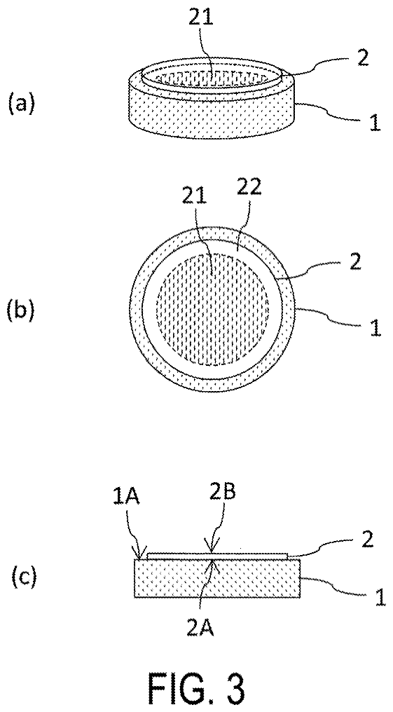

According to the above-described methods (1) to (3), a molded article is formed in which the first surface is adhered to the molding surface of the mold. FIG. 3 illustrates a schematic diagram of an example of a state in which the first surface of the molded article is adhered to the molding surface of the mold, in which (a) is a perspective view, (b) is a top view, and (c) is a side view.

The first surface 2A of the molded article 2 is adhered to the molding surface 1A of the mold 1, and closely adhered thereto in a state where the patterned region 11 (not illustrated) of the molding surface 1A and the transfer region 21, in which the patterned shape of the patterned region 11 is transferred inversely, (the illustration of its patterned shape is omitted) fit together. Therefore, when the molded article 2 is released from the molding surface 1A of the mold 1, a load is applied to the patterned shape formed in the transfer region 21, which may result in warping in the entire molded article 2, and may deteriorate the positional precision of the patterned shape.

### [Mold-Release Method of First Aspect of the Present Invention]

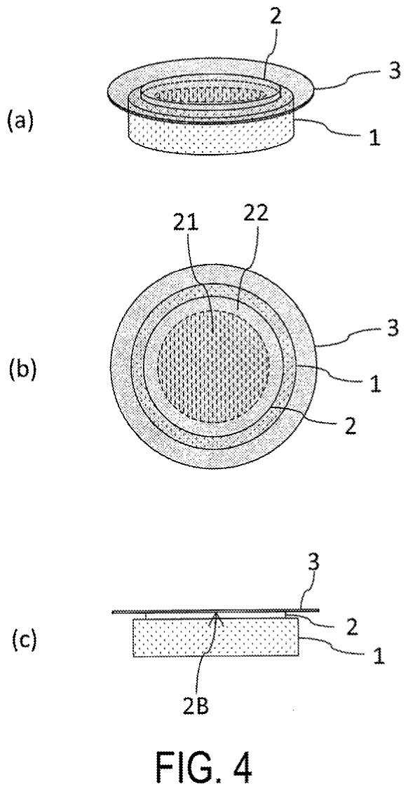

Step (1a) of the mold-release method of the first aspect of the present invention is a step of attaching a base material (hereinafter, sometimes referred to as “base material of the present invention”) to the entire second surface of the molded article. FIG. 4 illustrates an example of step (1a) of the mold-release method of the first aspect of the present invention. A base material 3 of the present invention is attached onto the entire second surface 2B of the molded article 2 of the present invention.

The expression “the base material is attached onto the entire second surface” means that the base material is attached not only onto the non-transfer regions 22 of the second surface, but also onto the entire surface of the second surface corresponding to the transfer region 21. However, when a concave part is present in the second surface, the portion of the concave part may not be in contact with the base material. In other words, it suffices that the entire planar part present on the second surface is attached onto the base material.

The material constituting the base material of the present invention is not particularly limited, and paper, resins, non-woven fabrics, metals, glass, silicon, and the like can be used. However, a resin is preferred in order to uniformly distribute the load during mold release throughout the molded article.

The resin as the material constituting the base material of the present invention is not particularly limited, and examples thereof include polyolefins such as polyethylene and polypropylene, ethylene-vinyl acetate copolymers, polyvinyl chloride, polyvinyl chloride-vinyl acetate copolymers, poly(meth) acrylic acid esters, polystyrene, polyvinyl alcohol, ethylene-vinyl alcohol copolymers, cellulose derivatives such as cellulose acetate, polyesters (polyalkylene terephthalates such as polyethylene terephthalate and polybutylene terephthalate, polyalkylene naphthalates such as polyethylene naphthalate and polybutylene naphthalate, etc.), polycarbonate, polyamides (polyamide 6, polyamide 6/6, polyamide 6/10, polyamide 6/12, etc.), polyester amide, polyether, polyimide, polyamide imide, and polyether ester, and copolymers, blends, and crosslinked products thereof may be used. Polyester resins and polyolefin resins are preferred in order to uniformly distribute the load during mold release throughout the molded article.

The base material of the present invention is not particularly limited in its form, and may be in a film form, a sheet form, or a plate form. However, in order to uniformly distribute the load during mold release throughout the molded article, the base material preferably is in a sheet form, and is particularly preferably a resin sheet.

When the base material of the present invention is in a sheet form, the area thereof is not particularly limited as long as the area is equal to or greater than that of the second surface of the molded article of the present invention. However, the area is preferably greater than that of the molding surface of the mold of the present invention to hold the end part of the base material in step (2a) which will be described below. A proportion of an area of the base material of the present invention relative to an area (100%) of the molding surface of the mold of the present invention is not particularly limited, but is preferably from 100 to 500%, more preferably from 100 to 400%.

When the base material of the present invention is in a sheet form, the thickness thereof is not particularly limited, but is preferably from 50 to 300 μm, more preferably from 50 to 200 μm, in order to uniformly distribute the load during mold release throughout the molded article.

The breaking strength of the base material of the present invention is not particularly limited, but is preferably from 20 to 200 MPa, more preferably from 25 to 180 MPa. The breaking strength of the base material of the present invention falling within this range makes it easy to uniformly distribute the load during mold release throughout the molded article. That is, when the breaking strength of the base material of the present invention is lower than 20 MPa, the base material of the present invention becomes too soft, and it may be difficult to uniformly distribute the load during mold release throughout the molded article. On the other hand, when the breaking strength of the base material of the present invention is higher than 200 MPa, the base material of the present invention may become too hard, and mold release itself may be difficult.

The breaking strength is a value measured at a sample size of 15 mm×10 mm and a pulling speed of 200 mm/min.

When the base material of the present invention is in a sheet form, the base material preferably has an adhesive layer on one surface thereof for fixing it to the second surface of the molded article of the present invention.

The adhesive constituting the adhesive layer is not particularly limited, but can be an acrylic adhesive, a rubber-based adhesive (such as a natural rubber-based adhesive, a synthetic rubber-based adhesive, or the like), a silicone-based adhesive, a polyester-based adhesive, a urethane-based adhesive, a polyamide-based adhesive, an epoxy-based adhesive, a vinyl alkylether adhesive, a fluorine-based adhesive, or the like. Only one, or two or more, of the adhesives described above may be used. The adhesive may be an adhesive in any form such as an emulsion-based adhesive, a solvent-based adhesive, a hot melt adhesive, an oligomeric adhesive, or a solid adhesive. An acrylic adhesive or the like is preferred from the viewpoint of easily distributing the load during mold release uniformly throughout the molded article.

The adhesive layer may be a single layer or a laminate composed of a plurality of layers. When the adhesive layer is the laminate composed of a plurality of layers, it may be a laminate of adhesive layers of the same type or a laminate of adhesive layers of different types. The adhesive layer may be laminated on the base material of the present invention via an intermediate layer, an undercoat layer, or the like.

The adhesive layer may be laminated on the entire surface of one surface, of the base material of the present invention, or may be laminated on a portion of one surface of the base material of the present invention as long as the adhesive layer can be closely adhered to the entire second surface of the molded article.

The adhesive layer may be protected by a mold release sheet, in which case the mold release sheet is removed prior to use in the mold-release method of the first aspect of the present invention.

The thickness of the adhesive layer is not particularly limited, but is preferably from 5 to 50 μm, more preferably from 5 to 40 μm, from the viewpoint of making it easy to uniformly disperse the load when release throughout the molded article.

The adhesive force of the adhesive layer is not particularly limited as long as the adhesive force allows the molded article to be released from the molding surface of the mold while the base material of the present invention is held on the second surface, but is preferably 3 N/20 mm or greater, more preferably 4 N/20 mm or greater, even more preferably 5 N/20 mm or greater. When the adhesive force of the adhesive layer is 3 N/20 mm or greater, the molded article can be reliably released from the molding surface of the mold, and the load during mold release is easily dispersed throughout the molded article, and thus the precision of the molded article is easily improved. On the other hand, the upper limit of the adhesive force of the adhesive layer is not particularly limited, but is preferably 25 N/20 mm or less, more preferably 24 N/20 mm or less, even more preferably 23 N/20 mm or less. When the adhesive force of the adhesive layer exceeds 25 N/20 mm, the release of the base material from the second surface of the molded article may become difficult after release of the molded article from the mold, resulting in deterioration in the precision of the molded article when the base material is peeled off, and occurrence of a glue residue on the second surface after peeling.

The adhesive force is a value measured as a 180° peel adhesive force to a silicon mirror wafer in accordance with JIS-Z-0237.

The adhesive constituting the adhesive layer may be either a non-curable adhesive or a curable adhesive. In a case where the adhesive is a curable adhesive, it may be either a heat-curable adhesive or a photo-curable adhesive (an adhesive which can be cured by active energy rays such as ultraviolet rays or electron beams). In a case where the adhesive is a curable adhesive, the adhesive hardens by heating or light irradiation after performing the mold-release method of the first aspect of the present invention. Therefore, it is easy to peel off the formed molded article of the present invention from the base material.

Commercially available adhesive sheets can be used as the base material of the present invention without limitation, and examples thereof include adhesive tapes, UV release tapes, and heat release tapes which are commonly sold by Nitto Denko Corporation, Lintec Corporation, 3M, Furukawa Electric Co., Ltd., Denka Adtecs Co., Ltd., etc.

Step (1a) of the mold-release method of the first aspect of the present invention is not particularly limited, but, in a case where the base material of the present invention is a sheet having an adhesive layer, step (1a) can be carried out by attaching the adhesive layer onto the entire second surface of the molded article to attain close adhesion. The surface of the base material of the present invention, which does not have an adhesive layer, may be pressed with a roller or the like so that the adhesive layer is reliably adhered closely to the entire second surface.

Step (2a) of the mold-release method of the first aspect of the present invention includes relatively moving the base material and the mold in a direction in which the base material of the present invention and the mold of the present invention are separated from each other, and thereby releasing the molded article of the present invention from the mold. Step (2a) releases the molded article from the molding surface of the mold while the molded article is held on the base material.

The relative movement of the base material and/or mold is not limited as long as the movement separates the base material and the mold from each other. The base material may be moved alone, the mold may be moved alone, or both of them may be moved. However, in order to efficiently release the molded article from the mold, it is preferable to fix the mold and move the base material in a direction in which it is separated from the mold.

The base material and/or the mold may be moved without limitation, but may be moved manually, and, for example, may be may be moved while the end part of the base material is held on a holding member.

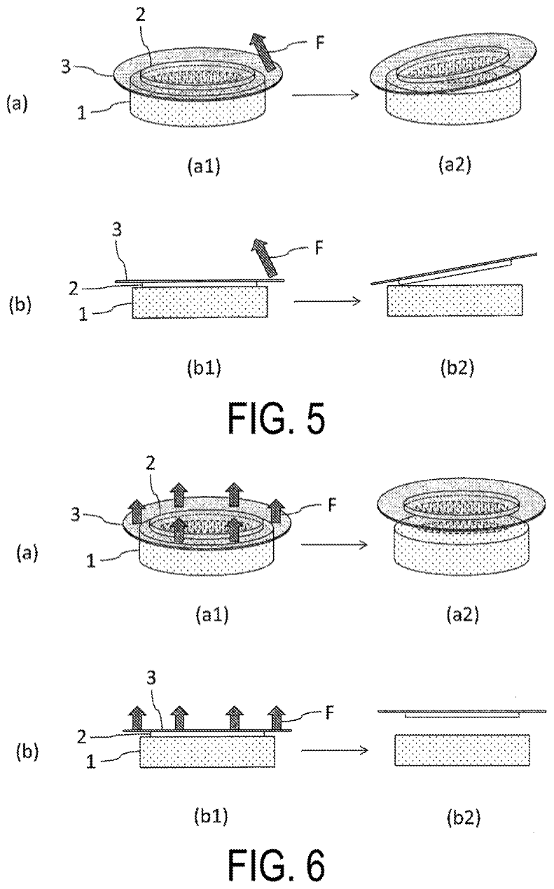

FIG. 5 illustrates an example of step (2a) of the mold-release method of the first aspect of the present invention, in which (a) is a perspective view and (b) a side view. One place of an end part of the base material 3 is held manually or by the holding member. A force F is applied to the end part in such a manner that the end part is tilted in a center direction of the base material 3 and the base material 3 is separated in an oblique direction, as illustrated in FIGS. 5(a1) and (b1). Thus, the base material is separated obliquely from the mold, so that the molded article 2 is released from the molding surface of the mold 1 while the molded article 2 is held on the base material 3, as illustrated in FIGS. 5(a2) and (b2).

FIG. 6 illustrates another example of step (2a) of the mold-release method of the first aspect of the present invention, in which (a) is a perspective view and (b) a side view. At least two places of an end part of the base material 3 are held manually or by the holding member. The forces F are applied simultaneously in a vertical direction to the at least two places of the end part in such a manner that the base material is separated from the mold, as illustrated in FIGS. 6(a1) and (b1). Thus, the base material is separated horizontally from the mold, so that the molded article 2 is released from the molding surface of the mold 1 while the molded article 2 is held on the base material 3, as illustrated in FIGS. 6(a2) and (b2).

In order to uniformly distribute the load throughout the molded article during mold release and improve the precision of the molded article, an aspect in which the end part of the base material is separated from the mold in an oblique direction, and the molded article is released from the molding surface of the mold while the molded article is held on the base material, as illustrated in FIG. 5, is preferred.

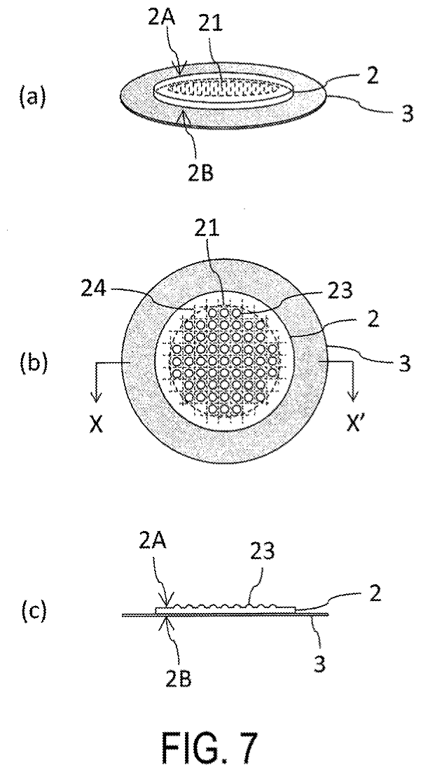

A molded article having the second surface adhered to the base material can be obtained by the mold-release method of the first aspect of the present invention. FIG. 7 illustrates a schematic diagram of an example of a molded article obtained by the mold-release method of the first aspect of the present invention in which the base material is attached onto the second surface, in which (a) is a perspective view, (b) is a top view, and (c) is a cross-sectional view in X-X′.

FIG. 7(a) illustrates a perspective view of the molded article 2 having the second surface 2B adhered to the base material 3. The transfer region 21 where a patterned shape is transferred (the illustration of the patterned shape is omitted) is exposed in the first surface 2A of the molded article 2.

FIG. 7(b) illustrates a top view of the molded article 2 in which the second surface 2B is attached to the base material 3, and FIG. 7(c) is a cross-sectional view in X-X′. In FIG. 7(b), two or more optical elements 23 are arranged two-dimensionally in the transfer region 21 of the first surface 2A of the molded article 2. In the mold-release method of the first aspect of the present invention, when the molded article 2 is released from the molding surface 1A of the mold 1, the load is uniformly applied to the entire molded article 2. Thus, the warpage of the molded article 2 is small, and the positional precision between the two or more optical elements 23 is excellent.

The mold-release method of the first aspect of the present invention may further include the following step (3a) after step (2a): (3a) peeling the base material off from the second surface of the molded article formed in (2a).

According to step (3a) described above, the base material can be peeled off from the second surface of the molded article to form, for example, the molded article 2 illustrated in FIG. 2.

The method of peeling off the base material from the second surface of the molded article is not particularly limited, and the method can be carried out by holding at least one place of the end part of the base material and relatively moving the base material and/the molded article in a direction in which the base material is separated from the molded article. Relative separation movement of the base material and/the molded article is not particularly limited, and can be performed, for example, in the same manner as the method of relative separation movement of the base material and/the mold as illustrated in FIGS. 5 and 6.

In a case where the adhesive of the adhesive layer is a curable adhesive as described above, the adhesive hardens by heating or light irradiation. Therefore, it is easy to peel off the molded article of the present invention from the base material.

In addition, in a case where the molded article is an array of optical elements, it is preferable that the mold-release method of the first aspect of the present invention should further include the following step (3a′) after step (2a):

(3a′) dicing the molded article (i.e., array of optical elements) obtained in (2a), the molded article having a plurality of optical elements arranged two-dimensionally on the first surface and the second surface fixed by the base material, thereby making the optical elements into individual optical members.

FIGS. 7(b) and (c) each illustrate a state in which the second surface 2B of the molded article 2 which is an array of optical elements is fixed to the base material 3. The base material 3 may function also as a dicing tape, and it is possible to dice the molded article 2 which is an array of optical elements fixed to the base material 3 to make the optical elements 23 into individual optical members.

The optical elements 23 can be made into individual optical members by dicing the molded article 2 which is an array of optical elements along a cutting line 24 in FIG. 7(b). Dicing provides optical members in which a substrate part corresponding to the substrate of the molded article 2 is bonded to the periphery of the respective individual optical elements 23. The molded article 2, which is an array of optical elements obtained by the mold-release method of the first aspect of the present invention, has little warpage, high positional precision of the two or more optical elements 23, and little deviation, so can provide a plurality of optical members uniform in shape.

The process of making the array of the optical elements into individual optical members is not particularly limited, and well-known and commonly used means can be employed. Among others, a dicing blade rotating at high speed is preferably used.

In cutting using a dicing blade rotating at high speed, the rotation speed of the dicing blade is, for example, approximately from 10000 to 50000 rpm. Furthermore, cutting the array of optical elements using a blade rotating at high speed may generate frictional heat. And thus, it is preferred to cut the array of optical elements while cooling, in terms of being able to suppress deformation of the optical elements and reduction in optical properties due to the frictional heat.

In cutting the array of optical elements using a dicing blade, the base material of the present invention is preferably not subjected to cutting. In this case, the individual optical members are fixed to the base material at the second surface, and the optical members can be removed by picking up individual optical members from the base material.

### [Mold-Release Method of Second Aspect of the Present Invention]

The mold-release method of the first aspect of the present invention can preferably be carried out by the mold-release method according to a second aspect of the present invention.

Step (1b) of the mold-release method of the second aspect of the present invention is a step of attaching an adhesive sheet having an adhesive force of 3 N/20 mm or more onto the entire second surface of the molded article.

### [Adhesive Sheet]

In the mold-release method of the second aspect of the present invention, the adhesive sheet of the present invention has an adhesive force of 3 N/20 mm or more. When the adhesive force of the adhesive sheet is 3 N/20 mm or more, the molded article is reliably released from the molding surface of the mold while the adhesive sheet of the present invention is held on the second surface, and the load during mold release is easily dispersed throughout the molded article, so that the precision of the molded article can be easily improved. That is, in a case where the adhesive force of the adhesive sheet of the present invention is less than 3 N/20 mm, the adhesive sheet may be insufficiently adhered to the second surface, and the mold release itself is difficult. Even when mold release is possible, a certain portion of the molded article may receive a large load at the start of release, and the precision of the molded article tends to be deteriorated. From the viewpoint of further improvement in precision of the molded article, the adhesive force of the adhesive sheet of the present invention is preferably 3 N/20 mm or greater, more preferably 4 N/20 mm or greater, even more preferably 5 N/20 mm or greater.

On the other hand, the upper limit of the adhesive force of the adhesive sheet of the present invention is not particularly limited, but is preferably 25 N/20 mm or less, more preferably 24 N/20 mm or less, even more preferably 23 N/20 mm or less. In a case where the adhesive force of the adhesive sheet of the present invention exceeds 25 N/20 mm, it may be difficult to release the adhesive sheet of the present invention from the second surface of the molded article after release of the molded article from the mold, resulting in deterioration in the precision of the molded article when the adhesive sheet is peeled off, and occurrence of a glue residue on the second surface after peeling.

The adhesive force is a value measured as a 180° peel adhesive force to a silicon mirror wafer in accordance with JIS-Z-0237.

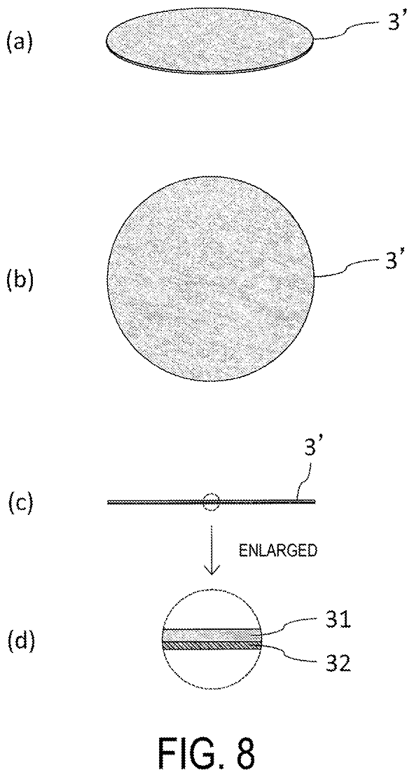

FIG. 8 illustrates a schematic diagram of an example of the adhesive sheet of the present invention, in which (a) is a perspective view, (b) is a top view, (c) is a side view, and (d) is an enlarged view of the side view.

The configuration of the adhesive sheet of the present invention is not particularly limited as long as the adhesive sheet is in a sheet form having at least one of the surfaces exhibiting tackiness. But it is preferable that the adhesive sheet should be a laminate of the base material 31 and an adhesive layer 32 laminated on one surface of the base material 31 such that the load is distributed uniformly throughout the molded article during mold release.

The material constituting the base material 31 is not particularly limited, and paper, resins, non-woven fabrics, metals, glass, silicon, and the like can be used. However, a resin is preferred to uniformly distribute the load during mold release throughout the molded article.

The resin as the material constituting the base material 31 is not particularly limited, and examples thereof include polyolefins such as polyethylene and polypropylene, ethylene-vinyl acetate copolymers, polyvinyl chloride, polyvinyl chloride-vinyl acetate copolymers, poly(meth) acrylic acid esters, polystyrene, polyvinyl alcohol, ethylene-vinyl alcohol copolymers, cellulose derivatives such as cellulose acetate, polyesters (polyalkylene terephthalates such as polyethylene terephthalate and polybutylene terephthalate, polyalkylene naphthalates such as polyethylene naphthalate and polybutylene naphthalate, etc.), polycarbonate, polyamides (polyamide 6, polyamide 6/6, polyamide 6/10, polyamide 6/12, etc.), polyester amide, polyether, polyimide, polyamide imide, and polyether ester, and copolymers, blends, and crosslinked products thereof may be used. Polyester resins and polyolefin resins are preferred to uniformly distribute the load during mold release throughout the molded article.

The thickness of the base material 31 is not particularly limited, but is preferably from 50 to 300 μm, more preferably from 50 to 200 μm, in order to uniformly distribute the load during mold release throughout the molded article.

The breaking strength of the base material 31 is not particularly limited, but is preferably 20 to 200 MPa, more preferably from 25 to 180 MPa. The breaking strength of the base material 31 falling within this range makes it easier to uniformly distribute the load during mold release throughout the molded article. That is, in a case where the breaking strength of the base material 31 is lower than 20 MPa, the adhesive sheet of the present invention becomes too soft, and it may be difficult to uniformly distribute the load during mold release throughout the molded article. On the other hand, in a case where the breaking strength of the base material 31 is higher than 200 MPa, the adhesive sheet of the present invention may become too hard, and mold release itself may be difficult.

The breaking strength is a value measured at a sample size of 15 mm×10 mm and a pulling speed of 200 mm/min.

The adhesive constituting the adhesive layer 32 is not particularly limited, but can be an acrylic adhesive, a rubber-based adhesive (such as a natural rubber-based adhesive, a synthetic rubber-based adhesive, or the like), a silicone-based adhesive, a polyester-based adhesive, a urethane-based adhesive, a polyamide-based adhesive, an epoxy-based adhesive, a vinyl alkylether adhesive, a fluorine-based adhesive, or the like. Only one, or two or more, of the adhesives described above may be used. The adhesive may be an adhesive in any form such as an emulsion-based adhesive, a solvent-based adhesive, a hot melt adhesive, an oligomeric adhesive, or a solid adhesive. An acrylic adhesive or the like is preferred from the viewpoint of easily distributing the load during mold release uniformly throughout the molded article.

The adhesive layer 32 may be a single layer or a laminate composed of a plurality of layers. When the adhesive layer 32 is the laminate composed of a plurality of layers, it may be a laminate of adhesive layers of the same type or a laminate of adhesive layers of different types. The adhesive layer may be laminated on the base material 31 via an intermediate layer, an undercoat layer, or the like.

The adhesive layer 32 may be laminated on the entire surface of one surface, of the base material 31 of the present invention, or may be laminated on a portion of one surface of the base material 31 of the present invention as long as the adhesive layer 32 can be closely adhered to the entire second surface of the molded article.

The adhesive layer 32 may be protected by a mold release sheet, in which case the mold release sheet is removed prior to use in the mold-release method of the second aspect of the present invention.

The thickness of the adhesive layer 32 is not particularly limited, but is preferably from 5 to 50 μm, more preferably from 5 to 40 μm, from the viewpoint of making it easy to uniformly disperse the load when release throughout the molded article.

The adhesive force of the adhesive layer 32 is not particularly limited as long as it is sufficient to release the molded article from the molding surface of the mold while the adhesive sheet of the present invention is held on the second surface, but, from the viewpoint of reliably releasing the molded article from the molding surface of the mold, and uniformly distributing the load during mold release throughout the molded article to improve the precision of the molded article, it is preferable to adjust the adhesive force to the equivalent range to that of the adhesive force of the adhesive sheet of the present invention described above.

The adhesive constituting the adhesive layer 32 may be either a non-curable adhesive or a curable adhesive. When the adhesive is a curable adhesive, it may be either a heat-curable adhesive or a photo-curable adhesive (a curable adhesive with active energy rays such as ultraviolet rays or electron beams). In a case where the adhesive is a curable adhesive, the adhesive hardens by heating or light irradiation after performing the mold-release method of the second aspect of the present invention. Therefore, it is easy to peel off the formed molded article of the present invention from the adhesive sheet of the present invention.

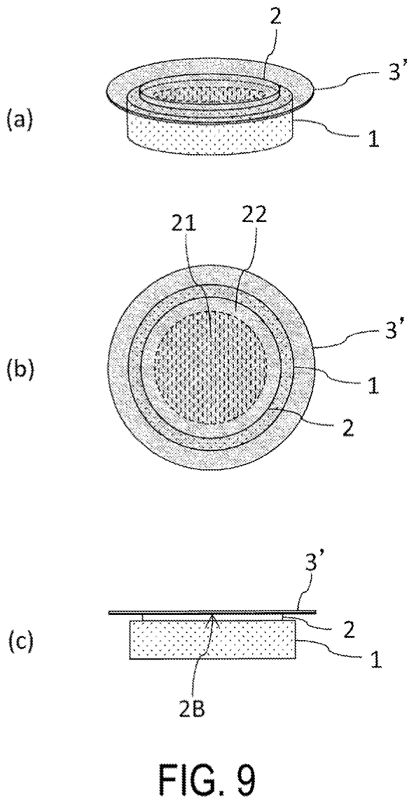

FIG. 9 illustrates an example of step (1b) of the mold-release method of the second aspect of the present invention. An adhesive sheet 3′ of the present invention is attached onto the entire second surface 2B of the molded article 2 of the present invention.

The expression that “the adhesive sheet is attached onto the entire second surface” means that the adhesive sheet of the present invention is attached not only onto the non-transfer regions 22 of the second surface, but also onto the entire surface of the second surface corresponding to the transfer region 21. However, when a concave part is present in the second surface, the portion of the concave part may not be in contact with the adhesive sheet. In other words, it suffices that the entire planar part present on the second surface is attached onto the adhesive sheet of the present invention.

The area of the adhesive sheet of the present invention is not particularly limited as long as the area is equal to or greater than that of the second surface of the molded article of the present invention. However, the area is preferably greater than that of the molding surface of the mold of the present invention to hold the end part of the adhesive sheet in step 2 which will be described below. A proportion of an area of the adhesive sheet of the present invention relative to an area (100%) of the molding surface of the mold of the present invention is not particularly limited, but is preferably from 100 to 500%, more preferably from 100 to 400%.

The thickness of the adhesive sheet (total thickness of the base material 31 and the adhesive layer 32) is not particularly limited, but is preferably from 55 to 350 μm, more preferably from 55 to 240 μm, in order to uniformly distribute the load during mold release throughout the molded article.

Commercially available adhesive sheets can be used as the adhesive sheet of the present invention without limitation, and examples thereof include adhesive tapes, UV release tapes, and heat release tapes which are commonly sold by Nitto Denko Corporation, Lintec Corporation, 3M, Furukawa Electric Co., Ltd., Denka Adtecs Co., Ltd., etc.

Step (1b) of the mold-release method of the second aspect of the present invention is not particularly limited, and can be carried out by attaching the adhesive sheet of the present invention onto the entire second surface of the molded article for attaining close adhesion. The surface of the adhesive sheet of the present invention, which is not attached onto the second surface of the adhesive sheet of the present invention, may be pressed with a roller or the like so that the adhesive sheet of the present invention is reliably adhered closely to the entire second surface.

Step (2b) of the mold-release method of the second aspect of the present invention includes relatively moving the adhesive sheet and the mold in a direction in which the adhesive sheet of the present invention and the mold of the present invention are separated from each other, and thereby releasing the molded article of the present invention from the mold. In (2b), the molded article is released from the molding surface of the mold while the molded article is held on the adhesive sheet.

The relative movement of the adhesive sheet and/or mold is not limited as long as the movement separates the adhesive sheet and mold from each other. The adhesive sheet may be moved alone, the mold may be moved alone, or both of them may be moved. However, in order to efficiently release the molded article from the mold, it is preferable to fix the mold and move the base material in a direction in which it is separated from the mold.

The adhesive sheet and/or the mold may be moved without limitation, but may be performed manually, and, for example, may be performed while the end part of the adhesive sheet is held on a holding member.

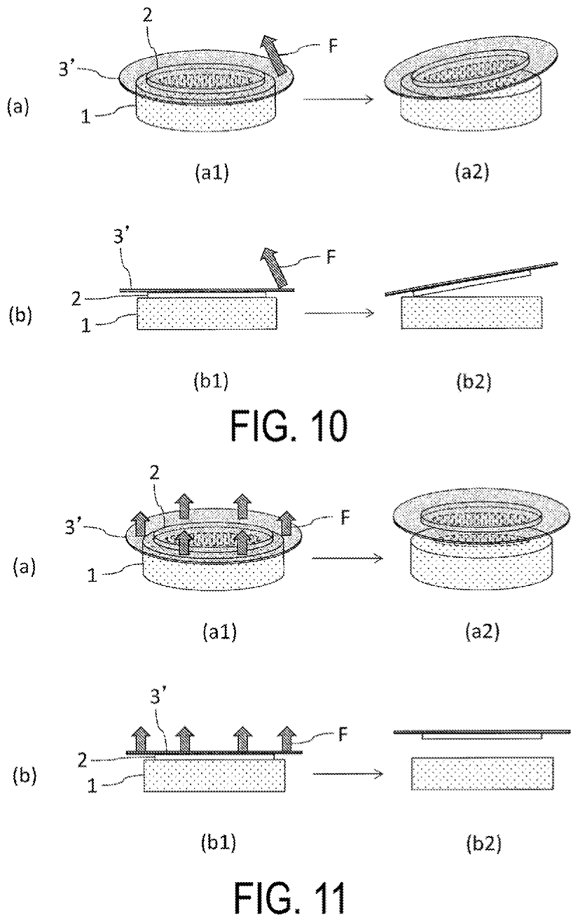

FIG. 10 illustrates an example of step (2b) of the mold-release method of the second aspect of the present invention, in which (a) is a perspective view and (b) a side view. One place of an end part of the adhesive sheet 3′ is held manually or by the holding member. A force F is applied to the end part in such a manner that the end part is tilted in a center direction of the adhesive sheet 3′ and the adhesive sheet 3′ is separated in an oblique direction, as illustrated in FIGS. 10(a1) and (b1). Thus, the adhesive sheet is separated obliquely from the mold, so that the molded article 2 is released from the molding surface of the mold 1 while the molded article 2 is held on the adhesive sheet 3′, as illustrated in FIGS. 10(a2) and (b2).

FIG. 11 illustrates another example of step (2b) of the mold-release method of the second aspect of the present invention, in which (a) is a perspective view and (b) a side view. At least two places of an end part of the adhesive sheet 3′ are held manually or by the holding member. The forces F are applied simultaneously in a vertical direction to the at least two places of the end part in such a manner that the at least two places of the end part are separated from the mold, as illustrated in FIGS. 11(a1) and (b1). Thus, the adhesive sheet 3 is separated horizontally from the mold, so that the molded article 2 is released from the molding surface of the mold 1 while the molded article 2 is held on the adhesive sheet 3′, as illustrated in FIGS. 11(a2) and (b2).

In order to uniformly distribute the load throughout the molded article during mold release and improve the precision of the molded article, as illustrated in FIG. 10, an aspect, in which the end part of the adhesive sheet of the present invention is separated from the mold in an oblique direction, and the molded article is released from the molding surface of the mold while the molded article is held on the adhesive sheet, is preferred.

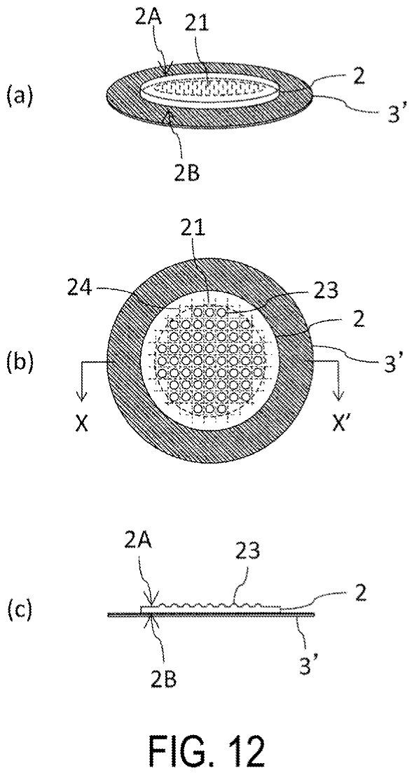

A molded article having the second surface adhered to the adhesive sheet of the present invention can be obtained by the mold-release method of the second aspect of the present invention. FIG. 12 illustrates a schematic diagram of an example of a molded article obtained by the mold-release method according to the second aspect of the present invention in which an adhesive sheet is attached onto a second surface, in which (a) is a perspective view, (b) is a top view, and (c) is a cross-sectional view in X-X′.

FIG. 12(a) illustrates a perspective view of the molded article 2 having the second surface 2B adhered to the adhesive sheet 3′. The transfer region 21 where a patterned shape is transferred (the illustration of the patterned shape is omitted) is exposed in the first surface 2A of the molded article 2.

FIG. 12(b) illustrates a top view of the molded article 2 in which the second surface 2B is adhered to the adhesive sheet 3′, and FIG. 12(c) is a cross-sectional view in X-X′. In FIG. 12(b), two or more optical elements 23 are arranged two-dimensionally in the transfer region 21 of the first surface 2A of the molded article 2. In the mold-release method of the second aspect of the present invention, when the molded article 2 is released from the molding surface 1A of the mold 1, the load is uniformly applied to the entire molded article 2. Thus, the warpage of the molded article 2 is small, and the positional precision between the two or more optical elements 23 is excellent.

The mold-release method of the second aspect of the present invention may further include the following step (3b) after step (2b):

(3b) peeling the adhesive sheet from the second surface of the molded article obtained in (2b).

According to step (3b) described above, the adhesive sheet can be peeled from the second surface of the molded article to form, for example, the molded article 2 illustrated in FIG. 2.

The method of peeling off the base material from the second surface of the molded article is not particularly limited, and the method can be carried out by holding at least one place of the end part of the adhesive sheet and relatively moving the adhesive sheet and/the molded article in a direction in which the adhesive sheet is separated from the molded article. Relative separation movement of the adhesive sheet and/the molded article is not particularly limited, and can be performed, for example, in the same manner as the method of relative separation movement of the adhesive sheet and/the mold as illustrated in FIGS. 10 and 11.

In a case where the adhesive of the adhesive layer 32 of the adhesive sheet of the present invention is a curable adhesive as described above, the adhesive hardens by heating or light irradiation. Therefore, it is easy to peel off the molded article of the present invention from the adhesive sheet.

In addition, in a case where the molded article is an array of optical elements, it is preferable that the mold-release method of the second aspect of the present invention should further include the following step (3b′) after step (2b)

(3b′) dicing the molded article (i.e., array of optical elements) obtained in (2b), the molded article having a plurality of optical elements arranged two-dimensionally on the first surface and the second surface fixed by the adhesive sheet, thereby making the optical elements into individual optical members.

FIGS. 12(b) and (c) each illustrate a state in which the second surface 2B of the molded article 2 which is an array of optical elements is fixed to the adhesive sheet 3′. The adhesive sheet 3′ may function also as a dicing tape, and it is possible to dice the molded article 2 which is an array of optical elements fixed to the adhesive sheet 3′ to make the optical elements 23 into individual optical members.

The optical elements 23 can be made into individual optical members by dicing the molded article 2 which is an array of optical elements along a cutting line 24 in FIG. 12(b). Dicing provides optical members in which a substrate part corresponding to the substrate of the molded article 2 is bonded to the periphery of the respective individual optical elements 23. The molded article 2, which is an array of optical elements obtained by the mold-release method of the second aspect of the present invention, has little warpage, high positional precision of the two or more optical elements 23, and little deviation, so can provide a plurality of optical members uniform in shape.

The process of making the array of the optical elements into individual optical members is not particularly limited, and well-known and commonly used means can be employed. Among others, a dicing blade rotating at high speed is preferably used. The cutting method using a dicing blade rotating at high speed can be carried out in the same manner as described above.

In cutting the array of optical elements using a dicing blade, the adhesive sheet of the present invention is preferably not subjected to cutting. In this case, the individual optical members are fixed to the adhesive sheet at the second surface, and the optical members can be removed by picking up the individual optical members from the adhesive sheet.

### [Mold-Release Device of the Present Invention]

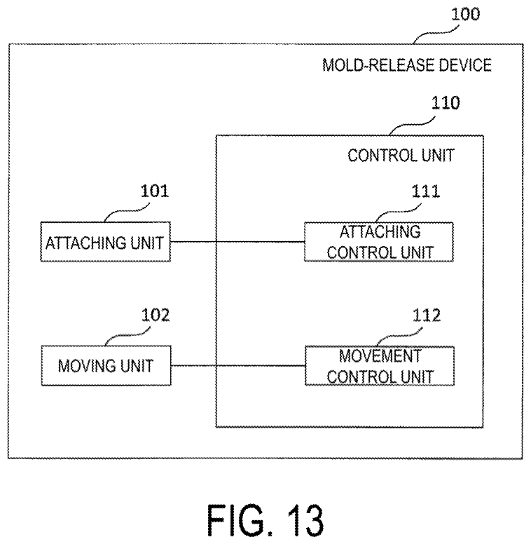

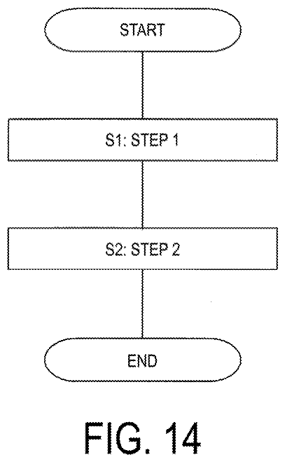

The mold-release method of the first aspect of the present invention may be carried out by a mold-release device of a third aspect of the present invention. The mold-release method of the second aspect of the present invention may be carried out by a mold-release device of a fourth aspect of the present invention. A mold-release device 100 according to the third and fourth aspects of the present invention will be described with reference to FIGS. 13 and 14. FIG. 13 is a block diagram illustrating the mold-release device 100 according to the third and fourth aspects of the present invention.

As illustrated in FIG. 13, the mold-release device 100 according to the third and fourth aspects of the present invention includes a attaching unit (attaching means) 101 and a moving unit (moving means) 102, and a control unit 110 includes a attaching control unit (attaching control means) 111 and a movement control unit (movement control means) 112.

In the mold-release device 100 of the third aspect of the present invention, the attaching unit 101 configured to attach the base material to the second surface of the molded article adhered to the molding surface of the mold. The moving unit 102 configured to move the base material and/or the mold relatively in a direction in which they are separated from or brought close to each other. The moving unit 102 may move only the base material, may move only the mold, or may move both the base material and the mold, but preferably moves only the base material. The control unit 110 configured to control the attaching unit 101 and the moving unit 102 to carry out the mold-release method of the first aspect of the present invention.

Also, in the mold-release device 100 of the fourth aspect of the present invention, the attaching unit 101 configured to attach the adhesive sheet of the present invention to the second surface of the molded article adhered to the molding surface of the mold. The moving unit 102 configured to move the adhesive sheet and/or the mold relatively in a direction in which they are separated from or brought close to each other. The moving unit 102 may move only the adhesive sheet, may move only the mold, or may move both the adhesive sheet and the mold, but preferably moves only the adhesive sheet. The control unit 110 configured to control the attaching unit 101 and the moving unit 102 to carry out the mold-release method of the second aspect of the present invention.

Next, processing of each of the units of the control unit 110 will be described with reference to FIG. 14. FIG. 14 is a flowchart illustrating a flow of the mold-release method according to the third and fourth aspects of the present invention.

In the mold-release device 100 of the third aspect of the present invention, the attaching control unit 111 configured to control the attaching unit 101 to carry out (1a) of attaching the base material onto the second surface. The attaching unit 101 configured to attach the base material onto the entire second surface of the molded article in accordance with the control from the attaching control unit 111 (S1: step 1). Also, in the mold-release device 100 of the fourth aspect of the present invention, the attaching control unit 111 configured to control the attaching unit 101 to carry out step (1b) of attaching the adhesive sheet of the present invention onto the second surface. The attaching unit 101 configured to attach the adhesive sheet of the present invention onto the entire second surface of the molded article in accordance with the control from the attaching control unit 111 (S1: step 1). In the mold-release device 100 according to the third and fourth aspects of the present invention, commercially available attaching devices for an adhesive sheet, control units thereof and the like can be used as the attaching unit 101 and the attaching control unit 111 without need to separately construct a high-precision control system.

In the mold-release device 100 of the third aspect of the present invention, after step (1a), the movement control unit 112 is configured to control the moving unit 102 so as to carry out a step (2a) in which the base material and the mold are relatively moved in a direction in which the base material and/or the mold are/is separated. In accordance with the control from the movement control unit 112, the moving unit 102 is configured to move the base material and/the mold relatively so that they are separated from each other (S2: step 2). The movement control unit 112 preferably makes adjustment such that the end part of the base material is held by the holding member (for example, a robotic hand) of the moving unit 102, and the force F is applied to the end part of the base material, as illustrated in FIG. 5 or 6. Also, in the mold-release device 100 of the fourth aspect of the present invention, after step (1b), the movement control unit 112 is configured to control the moving unit 102 so as to carry out a step (2b) in which the adhesive sheet and the mold are relatively moved in a direction in which the adhesive sheet and/or the mold are/is separated. In accordance with the control from the movement control unit 112, the moving unit 102 is configured to move the adhesive sheet and/the mold relatively so that they are separated from each other (S2: step 2). The movement control unit 112 preferably makes adjustment such that the end part of the adhesive sheet is held by the holding member (for example, a robotic hand) of the moving unit 102, and the force F is applied to the end part of the adhesive sheet, as illustrated in FIG. 10 or 11. In the mold-release device 100 according to the third and fourth aspects of the present invention, commercially available robotic hands, robot arms, control units thereof, and the like can be used as the moving unit 102 and the movement control unit 112 without need to separately construct a high-precision control system.

The mold-release device of the third aspect of the present invention may optionally include a second moving unit and a second movement control unit for carrying out step (3a). Further, the mold-release device of the fourth aspect of the present invention may optionally include a second moving unit and a second movement control unit for carrying out (3b). As the second moving unit and the second movement control unit, commercially available robot hands, robotic arms, control units thereof, and the like, which are similar to those for the moving unit 102 and the movement control unit 112 can be used.

The mold-release device of the third aspect of the present invention may optionally include a dicing unit and a dicing control unit for carrying out step (3a′). The mold-release device of the present invention may optionally include a dicing unit and a dicing control unit for carrying out step (3′). Commercially available dicing devices, control parts thereof, and the like can be used as the dicing unit and the dicing control unit.

The present invention is not limited to the embodiments described above, and various modifications are possible within the scope of the claims, and embodiments obtained by appropriately combining technical means disclosed in different embodiments are also encompassed within the technical scope of the present invention.

### EXAMPLES

Examples and comparative examples of typical embodiments of the present invention will be illustrated, but the present invention is not limited thereto. These examples are merely illustrative.

Note that the adhesive force of the adhesive sheet used in the examples was measured as a 180° peel adhesive force to a silicon mirror wafer in accordance with JIS-Z-0237.

### Production Example 1

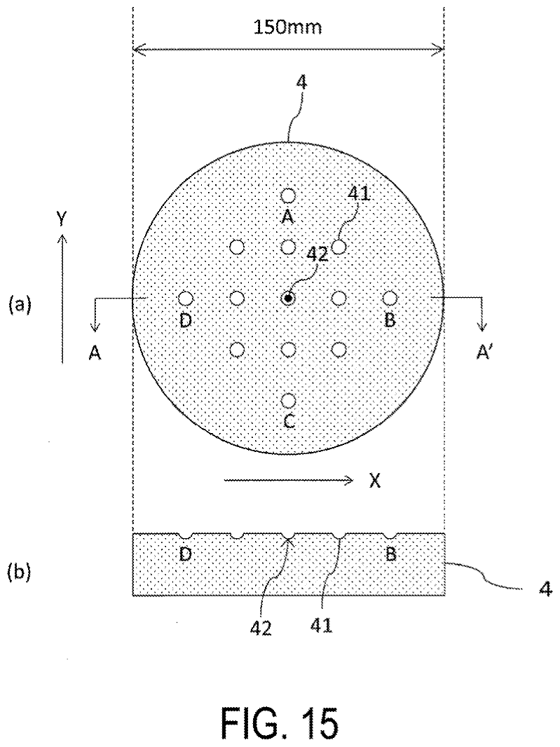

Prepared was a silicone resin mold (bottom mold 4) with a diameter of 150 mm and a height of 3 mm illustrated in FIG. 15, in which (a) is a top view and (b) is a cross-sectional view in A-A′. A plurality of concave parts 41 are arranged on a molding surface of the bottom mold 4 as illustrated in FIG. 15(a).

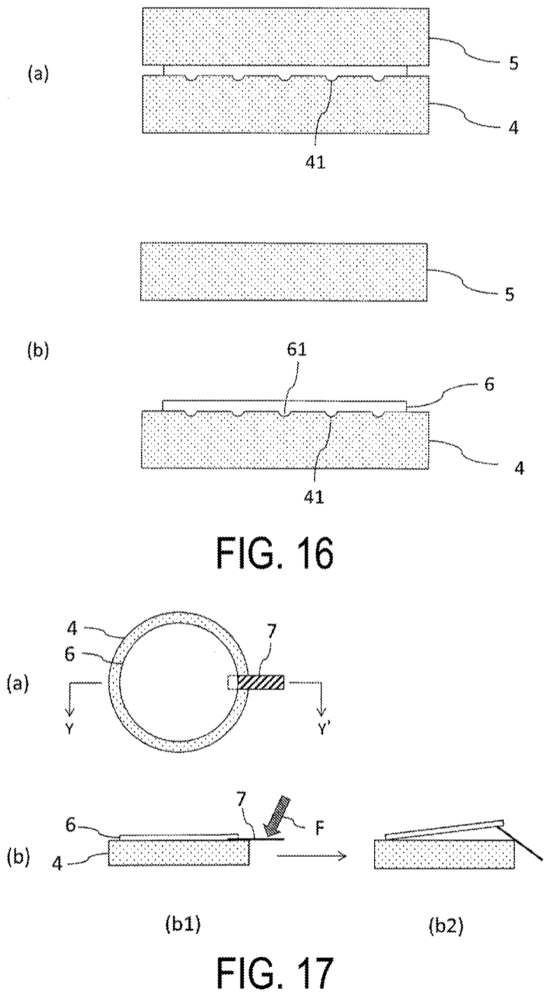

After the molding surface of the bottom mold 4 was dip-coated with a fluoro-based mold-release agent (OPTOOL HD-1100 available from Daikin Industries Co., Ltd.), 10 g of an epoxy resin (CELVENUS106 available from Daicel Co., Ltd.) was added dropwise. A silicone resin plate (top mold 5, planar substrate) of the same size whose surface was subjected to mold-release treatment with the fluoro-based mold-release agent was placed to close the mold (see FIG. 16(a)) such that the thickness of the epoxy resin was approximately 0.5 mm. UV irradiation was performed at 100 mW/cm²×30 sec. When the top mold 5 was removed, a resin wafer 6, in which convex parts 61 were respectively formed at positions corresponding to the concave parts 41 of the bottom mold 4, was obtained as a cured product of the epoxy resin in a state in which the resin wafer 6 was adhered to the molding surface of the bottom mold 4 (see FIG. 16(b)).

### Example 1

While the resin wafer 6 was adhered to the molding surface of the bottom mold 4 obtained in Production Example 1, an adhesive sheet (available from SRL-0759 available from Lintec Corporation) was attached to the entire surface of the resin wafer 6, the surface being formed by removing the top mold 5. An end part of the adhesive sheet was pulled with a force F in an oblique direction in a manner as illustrated in FIG. 5, so that the resin wafer 6 was released from the bottom mold 4.

### Comparative Example 1

An explanatory view illustrating a mold-release method of Comparative Example 1 is illustrated in FIG. 17, in which (a) is a top view and (b) is a cross-sectional view in Y-Y′.

While the resin wafer 6 was adhered to the molding surface of the bottom mold 4 obtained in Production Example 1, a metallic spatula 7 having a flat tip was inserted between the bottom mold 4 and the resin wafer 6 at any one point on the outer periphery in a manner as illustrated in FIG. 17(a). A force F was applied with the spatula 7 using the principle of leverage in a manner as illustrated in FIG. 17(b1) to release the resin wafer 6 from the molding surface of the bottom mold 4 as illustrated in FIG. 17(b2).

### Comparative Example 2

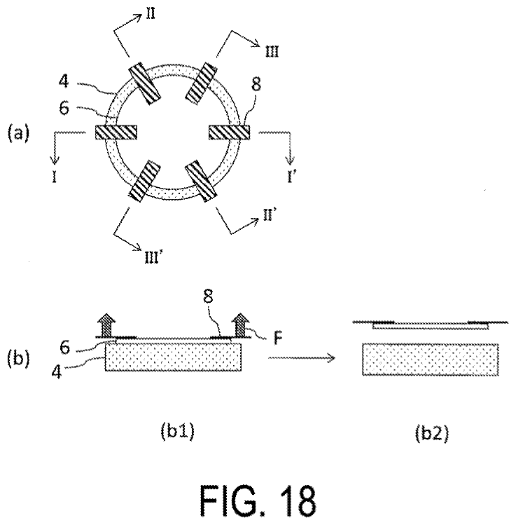

An explanatory view illustrating a mold-release method of Comparative Example 2 is illustrated in FIG. 18, in which (a) is a top view and (b) is a cross-sectional view in I-I′, or

While the resin wafer 6 was adhered to the molding surface of the bottom mold 4 obtained in Production Example 1, an adhesive tape 8 of 30 mm in length×10 mm in width was attached onto arbitrary-chosen six points on the outer periphery of the resin wafer 6 in a manner as illustrated in FIG. 18(a). A force F was applied simultaneously to the respective six points to lift the end parts of the respective adhesive tapes 8 in a manner as illustrated in FIG. 18(b1), and the resin wafer 6 was released from the molding surface of the bottom mold 4 in a manner as illustrated in FIG. 18(b2).

### Evaluation

The following evaluation tests were performed on the resin wafers obtained in the example and the comparative examples.

The warpage of each of the released resin wafers was measured using a surface shape measurement system (Dyvoce available from Kohzu Precision Co., Ltd.), and the positional precision thereof was measured using a CNC image measurement system (NEXIV-VMR-3030 available from Nikon Corporation).

The warpage was determined from [(peak top)−(bottom)] (μm) by measuring the in-plane height of the resin wafer 6.

The positional precision was evaluated based on the deviation of the convex parts 61 in the X and Y directions from the positions of the corresponding concave parts 41 of the bottom mold 4, with the position of the center of the resin wafer 6 used as a reference. Specifically, the X and Y coordinates were measured at the four points of the convex parts 61 corresponding to the concave parts 41 at A to D approximately 50 mm distant from the concave part 41 at a reference point 42, as the measuring points, and the magnitudes (mm) of the deviations from the concave part 41 were evaluated. The measuring point of each of the convex parts 61 was a hemispherical vertex position with a height of 0.2 mm and a diameter of 1 mm. The results are shown in Table 1.

TABLE 1

| | | | | Comparative | Comparative |
|---|---|---|---|---|---|
| | | | Example 1 | Example 1 | Example 2 |
| Warpage (μm) | | | 121 | 439 | 240 |
| Positional | A | X | 0.002 | 0.010 | 0.006 |
| precision | | Y | 0.019 | 0.070 | 0.030 |
| (mm) | B | X | 0.017 | −0.005 | 0.062 |
| | | Y | 0.003 | −0.108 | 0.009 |
| | C | X | 0.005 | −0.012 | 0.004 |
| | | Y | 0.021 | −0.053 | 0.079 |
| | D | X | 0.019 | 0.087 | 0.047 |
| | | Y | 0.003 | 0.017 | 0.004 |

### Example 2

While the resin wafer 6 was adhered to the molding surface of the bottom mold 4 obtained in Production Example 1, an adhesive sheet having an adhesive force of 17 N/20 mm (ADWILL D-210 available from Lintec Corporation, base material: made of polyethylene terephthalate, and adhesive layer: acrylic adhesive) was attached to the entire surface of the resin wafer 6, the surface being formed by removing the top mold 5. An end part of the adhesive sheet was pulled with a force F in an oblique direction in a manner as illustrated in FIG. 10, so that the resin wafer 6 was released from the bottom mold 4. The positional precision of the released resin wafer was evaluated by the method described above. The results are shown in Table 2.

### Example 3

The resin wafer 6 was released from the bottom mold 4 in the same manner as in Example 2 with the exception that an adhesive sheet having an adhesive force of 3.4 N/20 mm (UC3044M-110B available from Furukawa Electric Co., Ltd., base material: made of polyolefin, and adhesive layer: acrylic adhesive) was used. The positional precision of the released resin wafer was evaluated by the method described above. The results are shown in Table 2.

TABLE 2

| | | | Example 2 | Example 3 |
|---|---|---|---|---|
| Positional | A | X | 0.002 | 0.005 |
| precision | | Y | 0.019 | 0.028 |
| (mm) | B | X | 0.017 | 0.034 |
| | | Y | 0.003 | 0.011 |
| | C | X | 0.005 | 0.004 |
| | | Y | 0.021 | 0.026 |
| | D | X | 0.019 | 0.035 |
| | | Y | 0.003 | 0.009 |

Variations of embodiments of the present invention described above are additionally described below.

[1] A mold-release method for a molded article from a mold,

the molded article being formed by curing a curable material supplied to a molding surface of the mold, and having a first surface onto which a patterned shape of the molding surface is transferred and a second surface on a back side opposite to the first surface,

the method including:

(1a) attaching a base material onto the entire second surface of the molded article; and

(2a): relatively moving the base material and the mold in a direction in which the base material and the mold are separated from each other, and thereby releasing the molded article from the mold.

[2] The method according to [1], wherein the molded article is an array in which two or more optical elements are arranged two-dimensionally on the first surface and the array has a substrate part that joins the optical elements together.

[3] The method according to [1] or [2], wherein at least a planar part onto which the base material is attachable is present on the second surface.

[4] The method according to [3], wherein a proportion of an area of the planar part relative to a total area (100%) of the second surface is 15% or greater (preferably 25% or greater, more preferably 35% or greater).

[5] The method according to [3] or [4], wherein the second surface does not have a convex part with respect to the planar part.

[6] The method according to any one of [3] to [5], wherein the second surface has a concave part with respect to the planar part.

[7] The method according to [6], wherein a proportion of an area of the concave part relative to a total area (100%) of the second surface 2B is 85% or less (preferably 75% or less, more preferably 65% or less).

[8] The method according to any one of [1] to [7], wherein the base material is a resin sheet.

[9] The method according to [8], wherein the resin sheet has a thickness of from 50 to 300 μm (preferably from 50 to 200 μm).

[10] The method according to [8] or [9], wherein the resin sheet has an adhesive layer on one surface.

[11] The method according to [10], wherein the adhesive layer has a thickness of from 5 to 50 μm (preferably from 5 to 40 μm).

[12] The method according to [10] or [11], wherein the adhesive layer has an adhesive force of 3 N/20 mm or greater (preferably 4 N/20 mm or greater, more preferably 5 N/20 mm or greater).

[13] The method according to [11] or [12], wherein the adhesive layer has an adhesive force of 25 N/20 mm or less (preferably 24 N/20 mm or less, more preferably 23 N/20 mm or less).

[14] The method according to any one of [10] to [13], wherein the adhesive is a curable adhesive.

[15] The method according to any one of [1] to [14], wherein the base material has a breaking strength of from 20 to 200 MPa (preferably from 25 to 180 MPa).

[16] The method according to any one of [1] to [15], wherein, in (2a), an end part of the base material is tilted in a center direction of the base material and the base material is separated from the mold in an oblique direction.

[17] The method according to any one of [1] to [15], wherein, in (2a), at least two places of an end part of the base material are held, and the base material is separated from the mold simultaneously in a vertical direction with respect to the base material.

[18] The method according to any one of [1] to [17], further including: (3a) peeling the base material from the second surface of the molded article obtained in (2a).

[19] The method according to any one of [1] to [17], further including:

(3a′) dicing the molded article obtained in (2a), the molded article having a plurality of optical elements arranged two-dimensionally on the first surface and the second surface fixed by the base material, thereby making the optical elements into individual optical members.

[20] The method according to any one of [2] to [19], wherein the optical elements are wafer-level lenses.

[21] A mold-release method for a molded article from a mold, the molded article being formed by curing a curable material supplied to a molding surface of the mold, and having a first surface onto which a patterned shape of the molding surface is transferred and a second surface on a back side opposite to the first surface, the method including:

(1b) attaching an adhesive sheet having an adhesive force of 3 N/20 mm or more onto the entire second surface of the molded article; and

(2b) relatively moving the adhesive sheet and the mold in a direction in which the adhesive sheet and the mold are separated from each other, and thereby releasing the molded article from the mold.

[22] The method according to [21], wherein the molded article is an array in which two or more optical elements are arranged two-dimensionally on the first surface and the array has a substrate part that joins the optical elements together.

[23] The method according to [21] or [22], wherein at least a planar part onto which the adhesive sheet is attachable is present on the second surface.

[24] The method according to [23], wherein a proportion of an area of the planar part relative to a total area (100%) of the second surface is 15% or greater (preferably 25% or greater, more preferably 35% or greater).

[25] The method according to [23] or [24], wherein the second surface does not have a convex part with respect to the planar part.

[26] The method according to any one of [23] to [25], wherein the second surface has a concave part with respect to the planar part.

[27] The method according to [26], wherein a proportion of an area of the concave part relative to a total area (100%) of the second surface 2B is 85% or less (preferably 75% or less, more preferably 65% or less).

[28] The method according to any one of [21] or [27], wherein the adhesive sheet has an adhesive force of 3 N/20 mm or greater (preferably 4 N/20 mm or greater, more preferably 5 N/20 mm or greater).

[29] The method according to any one of [21] or [28], wherein the adhesive sheet has an adhesive force of 25 N/20 mm or less (preferably 24 N/20 mm or less, more preferably 23 N/20 mm or less).

[30] The method according to any one of [21] to [29], wherein the adhesive sheet is a laminate including a base material and an adhesive layer laminated on one surface of the base material, and the base material is a resin.

[31] The method according to [31], wherein the base material has a thickness from 50 to 300 μm (preferably from 50 to 200 μm).

[32] The method according to [30] or [31], wherein the base material has a breaking strength from 20 to 200 MPa (preferably from 25 to 180 MPa).

[33] The method according to any one of [30] to [32], wherein the adhesive layer 32 has a thickness from 5 to 50 μm (preferably from 5 to 40 μm).

[34] The method according to any one of [30] to [33], wherein the adhesive is of a curable adhesive.

[35] The method according to any one of [21] to [34], wherein the adhesive sheet has a thickness from 55 to 350 μm (preferably from 55 to 240 μm).

[36] The method according to any one of [21] to [35], wherein, in the (2b), an end part of the adhesive sheet is tilted in a center direction of the adhesive sheet and the adhesive sheet is separated from the mold in an oblique direction.

[37] The method according to any one of [21] to [35], wherein, in (2b), at least two places of an end part of the adhesive sheet are held, and the adhesive sheet is separated from the mold simultaneously in a vertical direction with respect to the adhesive sheet.

[38] The method according to any one of [21] to [37], further including:

(3b) peeling the adhesive sheet from the second surface of the molded article obtained in (2b).

[39] The method according to any one of [21] to [38], further including:

(3b′) dicing the molded article obtained in (2b), the molded article having a plurality of optical elements arranged two-dimensionally on the first surface and the second surface fixed by the adhesive sheet, thereby making the optical elements into individual optical members.

[40] The method according to any one of [22] to [39], wherein the optical element are wafer-level lenses.

[41] The method according to any one of [1] to [40], wherein the curable material is a curable epoxy resin composition.

[42] The method according to any one of [1] to [41], wherein the material constituting the mold is at least one selected from the group consisting of resins, metals, or glass (preferably a resin, more preferably a silicone resin).

[43] The method according to any one of [1] to [43], wherein at least a part of a patterned region of the molding surface of the mold is treated with a mold-release agent.

[44] A mold-release device for a molded article from a mold,

the molded article being formed by curing a curable material supplied to a molding surface of the mold, and having a first surface onto which a pattern of a molding surface is transferred and a second surface on a back side opposite to the first surface,

the device including:

an attaching unit configured to attach a base material onto the second surface;

a moving unit configured to move the base material and the mold relatively;

an attaching control unit configured to control the attaching unit to attach the base material onto the entire second surface of the molded article; and

a movement control unit configured to control the moving unit to relatively move the base material and the mold in a direction in which the base material and the mold are separated from each other.

[45] A mold-release device for a molded article from a mold,

the molded article being formed by curing a curable material supplied to a molding surface of the mold, and having a first surface onto which a patterned shape of the molding surface is transferred and a second surface on a back side opposite to the first surface,

the device including:

an attaching unit configured to attach an adhesive sheet onto the second surface;

a moving unit configured to move the adhesive sheet and the mold relatively;

an attaching control unit configured to control the attaching unit to attach the adhesive sheet onto the entire second surface of the molded article; and

a movement control unit configured to control the moving unit to relatively move the adhesive sheet and the mold in a direction in which the adhesive sheet and the mold are separated from each other.

### INDUSTRIAL APPLICABILITY

The mold-release method and mold-release device according to the present invention can be suitably used in the field of production of and production apparatuses for various optical members including a lens, a prism, an LED, an organic EL element, a semiconductor laser, a transistor, a solar cell, a CCD image sensor, an optical waveguide, an optical fiber, and an alternative glass (a display substrate, a hard disk substrate, a polarizing film, etc.), and an optical diffraction element.

### REFERENCE SIGNS LIST

1 Mold
11 Patterned region
12 Non-patterned region
1A Molding surface
2 Molded article
21 Transfer region
22 Non-transfer region
23 Optical element
24 Cutting line
2A First surface
2B Second surface
3 Base material
3′ Adhesive sheet
31 Base material
32 Adhesive layer
F (Direction of) Force
4 Bottom mold (resin mold)
41 Concave part
42 Reference point
5 Top mold (resin plate)
6 Resin wafer
61 Convex part
7 Metallic spatula
8 Adhesive tape

1. A mold-release method for a molded article from a mold,
the molded article being formed by curing a curable material supplied to a molding surface of the mold, and having a first surface onto which a patterned shape of the molding surface is transferred and a second surface on a back side opposite to the first surface,
the method comprising:
(1a) attaching a base material onto the entire second surface of the molded article; and
(2a) relatively moving the base material and the mold in a direction in which the base material and the mold are separated from each other, and thereby releasing the molded article from the mold.

2. The method according to claim 1, wherein the molded article is an array in which two or more optical elements are arranged two-dimensionally on the first surface and the array has a substrate part that joins the optical elements together.

3. The method according to claim 1, wherein at least a planar part onto which the base material is attachable is present on the second surface.

4. The method according to claim 1, wherein the base material is a resin sheet.

5. The method according to claim 4, wherein the resin sheet has an adhesive layer on one surface.

6. The method according to claim 1, further comprising:
(3a) peeling the base material from the second surface of the molded article formed in (2a).

7. The method according to claim 2, further comprising:
(3a′) dicing the molded article formed in (2a), the molded article having a plurality of optical elements arranged two-dimensionally on the first surface and the second surface fixed by the base material, thereby making the optical elements into individual optical members.

8. The method according to claim 2, wherein the optical elements are wafer-level lenses.

9. The mold-release method for a molded article from a mold according to claim 1,
the molded article being formed by curing a curable material supplied to a molding surface of the mold, and having a first surface onto which a patterned shape of the molding surface is transferred and a second surface on a back side opposite to the first surface,
the method comprising:
(1b) attaching an adhesive sheet having an adhesive force of 3 N/20 mm or more onto the entire second surface of the molded article; and
(2b) relatively moving the adhesive sheet and the mold in a direction in which the adhesive sheet and the mold are separated from each other, and thereby releasing the molded article from the mold.

10. The method according to claim 9, wherein the molded article is an array in which two or more optical elements are arranged two-dimensionally on the first surface and the array has a substrate part that joins the optical elements together.

11. The method according to claim 9, wherein at least a planar part onto which the adhesive sheet is attachable is present on the second surface.

12. The method according to claim 9, wherein the adhesive sheet is a laminate including a base material and an adhesive layer laminated on one surface of the base material, and the base material is a resin.

13. The method according to claim 9, further comprising:
(3b) peeling off the adhesive sheet from the second surface of the molded article formed in (2b).

14. The method according to claim 10, further comprising:
(3b′) dicing the molded article obtained in (2b), the molded article having a plurality of optical elements arranged two-dimensionally on the first surface and the second surface fixed by the adhesive sheet, thereby making the optical elements into individual optical members.

15. The method according to claim 10, wherein the optical elements are wafer-level lenses.

16. The method according to claim 1, wherein the curable material is a curable epoxy resin composition.

17. The method according to claim 1, wherein the material constituting the mold is at least one selected from the group consisting of resins, metals, or glass.

18. The method according to claim 1, wherein at least a part of a patterned region of the molding surface of the mold is treated with a mold-release agent.

19. A mold-release device for a molded article from a mold,
the molded article being formed by curing a curable material supplied to a molding surface of the mold, and having a first surface onto which a pattern of a molding surface is transferred and a second surface on a back side opposite to the first surface,
the device comprising:
an attaching unit configured to attach a base material onto the second surface;
a moving unit configured to move the base material and the mold relatively;
an attaching control unit configured to control the attaching unit to attach the base material onto the entire second surface of the molded article; and
a movement control unit configured to control the moving unit to relatively move the base material and the mold in a direction in which the base material and the mold are separated from each other.

20. The mold-release device for a molded article from a mold according to claim 19,
the molded article being formed by curing a curable material supplied to a molding surface of the mold, and having a first surface onto which a patterned shape of the molding surface is transferred and a second surface on a back side opposite to the first surface,
the device comprising:
an attaching unit configured to attach an adhesive sheet onto the second surface;
a moving unit configured to move the adhesive sheet and the mold relatively;
an attaching control unit configured to control the attaching unit to attach the adhesive sheet onto the entire second surface of the molded article; and
a movement control unit configured to control the moving unit to relatively move the adhesive sheet and the mold in a direction in which the adhesive sheet and the mold are separated from each other.
